(19) United States
(12) Patent Application Publication
(10) Pub. No.: US 2026/0326087 A1
(43) Pub. Date: Oct. 22, 2026

(54) METAL NANOPARTICLES STABILIZED WITH CATIONIC COMPOUNDS CAPABLE OF ABSORBING VISIBLE LIGHT

(71) Applicant: FUNDACIÓ EURECAT, CERDANYOLA DEL VALLÈS (ES)

(72) Inventors: MIRIAM DÍAZ DE LOS BERNARDOS SÁNCHEZ, TARRAGONA (ES); EMMA FERNÁNDEZ LLAMAZARES ARAGÓN, TARRAGONA (ES); IULIANA MARIA COTA, TARRAGONA (ES); MERITXELL CINTA SALVADÓ SALVADÓ, TARRAGONA (ES); BARTOSZ TYLKOWSKI, TARRAGONA (ES); JOAN TEICHENNÉ JANÉ, REUS (ES); JUAN MARÍA ALCAIDE HIDALGO, REUS (ES); ALFONSO DAVID LOAEZA BECERRIL, CERDANYOLA DEL VALLÈS (ES)

(21) Appl. No.: 19/485,361

(22) PCT Filed: May 17, 2024
(86) PCT No.: PCT/EP2024/063643

§ 371 Date: Nov. 18, 2025

(30) Foreign Application Priority Data
May 18, 2023 (EP) 23382468.9

(51) Int. Cl. B01J 23/52; B01J 21/06; B01J 35/39; B01J 35/45

(52) U.S. Cl. CPC B01J 23/52; B01J 21/063; B01J 35/39; B01J 35/45

(57) ABSTRACT

Metal nanoparticles including a metal and a capping agent coordinated to the metal, wherein the capping agent is a salt of a cationic compound capable of absorbing visible light. The metal nanoparticles can be incorporated in semiconductor metal oxide nanoparticles, a functionalised material comprising the semiconductor metal oxide nanoparticles, and a photocatalytic paint which includes either the semiconductor metal oxide nanoparticles or the functionalised material. The semiconductor metal oxide nanoparticles or the functionalised material comprising them can be used as biocides, particularly for the treatment or prevention of a viral disease or a bacterial infection, for removing Volatile Organic Compounds (VOCs) from of air and water supplies, and as a photocatalyst for water splitting.

This application claims the priority of the European Patent Application 23382468.9 filed on May 18, 2023.

The invention relates to the field of metal nanoparticles. Particularly, it relates to metal nanoparticles (MNPs) stabilized with a salt of a cationic compound capable of absorbing visible light. It also relates to semiconductor metal oxide nanoparticles (MONPs) which comprise the metal nanoparticles (MNP), and to a functionalised material comprising them. The invention also relates to the use of the semiconductor metal oxide nanoparticles or of the functionalised materials as biocides, disinfectants, or antiseptics, particularly for the treatment and/or prevention of a viral disease or a bacterial infection.

### BACKGROUND ART

The recent COVID-19 epidemiological situation has highlighted the need for innovation in new disinfection technologies and new antimicrobial materials such as photocatalysts. Metal oxides (as TiO₂ and ZnO) are popular antibacterial photocatalysts. However, their band gaps are too wide, requiring UV/blue illumination. Besides the very low carrier recombination lifetimes, highly intense illumination is needed.

On the other hand, metal nanoparticles, particularly gold nanoparticles (AuNPs), have been used in a broad spectrum of sectors including medicine, food industry, water purification, and biological applications. In particular, gold nanoparticles have been applied as drug-delivery systems, to photo-thermal therapy, as well as to imaging and/or sensing agents, catalysts, and also as biocides.

The properties of the metal nanoparticles can vary regarding the shape and/or size. Several shapes of gold nanoparticles have been disclosed in the state of the art, such as for example spherical, cluster, rod, shell, star, and cube, among others.

Many reactions have been disclosed to prepare stable metal (gold) nanoparticles. More specifically, two general tactics can be used to attain particles on the nanoscale. The first strategy known as “Bottom up technique” is such in which the atoms generated from ions reduction are accumulated to produce nanostructures. Examples of well-known bottom up techniques include templating, chemical, electrochemical, sonochemical, thermal and photochemical reduction techniques. The second strategy is based on “the top down technique” in which materials are detached from the bulk material, producing the preferred nanostructures only. Examples of well-known top down methods include photolithography and electron beam lithography.

The disadvantage of top down methods lack the ability to eliminate high quantities of material

Metal (gold) nanoparticles prepared by the methods mentioned above have been used as biocides. However, there is always the threat that metal nanoparticles could be toxic on exposure directly or through the environment due to their nanometric size or by inhalation (by detachment of components of the nanoparticles causing acute or long-term lung injury). Therefore, one of the prime objectives of the research of the recent years is the development of stable non-toxic metal nanoparticles useful as biocidal agents.

In this way, the modification of the surface of metal nanoparticles (gold and silver) with surface-enhanced agents has been disclosed in the state of the art. In particular, the addition of surface-enhanced Raman scattering (SERS) agent to gold and silver nanoparticles was prepared by successively spraying metal nanoparticles (NPs) onto several pigments such as malachite green (MG), methylene blue (MB), and crystal violet (CV).

Other biocides have been disclosed in the prior art. For example, Maslov et al (Microchemical Journal 2020) discloses a procedure for the removal of nickel in plant samples by combining vortex-assisted supramolecular-based dispersive liquid-liquid microextraction. It describes the formation of an organometallic complex between Ni (II) ions and three different ligands crystal violet, rhodamine B, and methylene blue as complexing reagents.

U.S. Pat. No. 8,580,309 and US2009317436 disclose a method for killing or preventing the growth of microbes, and a self-disinfecting computer input device, respectively, by using a mixture comprising charge-stabilized metallic nanoparticles and a photosensitiser such as crystal violet, or a metallic nanoparticle-ligand-photosensitiser conjugate, in which a photosensitiser is directly bound, via the ligand, to ligand-stabilised nanoparticles. In all cases, the photosensitiser is added to the nanoparticles once they have been already formed (and even linked to the ligand in the case of the conjugates).

Wybieralska et al (Polish Journal of Chemical Technology 2014) reports a study on the efficiency of magnetic iron nanoparticles modified with selected hydrophobic surfactants to purify water contaminated with organic dyes. It is disclosed that in a first step colloidal solutions of iron hydroxide (III) and iron oxide (II and III) were obtained, and then their particles were then subjected to surface modification using surfactants such as crystal violet.

Bakshi et al (Crystal Growth & Design 2008) discloses a seed-mediated approach to synthesize gold (Au) nanoparticles (NP) by using the twin tail alkylammonium cationic surfactants: Hexamethylene-1,6-bis(dodecyldimethylammonium bromide) (12-6-12) and didodecyldimethylammonium bromide (12-0-12) as capping agents in aqueous phase at ambient conditions. These surfactants are not capable of absorbing visible light.

Finally, Tawfik et al (Photodiagnosis and Photodynamic Therapy 2015) discloses a clinical study in which patients suffering from impetigo are treated with a methylene blue-gold nanoparticles conjugate. It is disclosed that the conjugates were obtained by first preparing the gold nanoparticles by using HAuCl₄ and trisodium citrate dehydrate, and then by adding an aqueous solution of methylene blue to the previously synthesized gold nanoparticles.

Therefore, from what is known in the state of the art, there is still the need of providing stable and safe nanocomposites being useful as biocidal agents.

### SUMMARY OF INVENTION

The inventors have developed new biocides with prolonged useful life and reduced cell toxicity based on metal nanoparticles (MNPs) stabilized with a photosensitizer, supported on semiconductor metal oxide nanoparticles (MONPs). The photosensitizers used in the present invention are salts of cationic compounds such as crystal violet (CV) or methylene blue (MB) which are capable of absorbing visible light and being active at low flux levels of visible light.

Without being bound to theory, it is thought that the photosensitizer has a bifunctional role: i) acts as a stabilizing agent preventing the agglomeration of the MNPs into larger particles and, ii) the heterojunction of the photosensitizer with the MNPs promote band gap reduction of the semiconductor. Thus, the incorporation of photosensitized MNPs into the MONPs enhances the photocatalytic reaction of the semiconductor metal oxide to visible light, making it able to absorb in the visible range and thus widening the irradiation sources that can be used, which enhances the activity of the material at low flux levels of white light.

As it is demonstrated in the experimental section, the semiconductor metal oxide nanoparticles (MONPs) of the present invention are surprisingly more active as biocidal agents than those analogues including metal nanoparticles stabilized with citrate (also referred herein to as Cit/AuNPs), even when a salt of a cationic compound capable of absorbing visible light, for example crystal violet is mixed with citrate-stabilized gold nanoparticles (CV+CIT/AuNPs).

The semiconductor metal oxide nanoparticles (MONPs) of the present invention have the required biocidal efficacy for treating a living tissue (acting as antiseptic agent) or inanimate objects (acting as disinfectant agents) including health care facilities. Besides the photobactericidal semiconductor metal oxide nanoparticles can be synthesized via facile one-pot methodology.

Furthermore, the inventors have found that the semiconductor metal oxide nanoparticles of the present invention are versatile enough to be anchored by an efficient and simple long-lasting covalent immobilization onto materials of a larger size, such for example polymeric microcapsules, thus increasing their particle size, and also allowing their immobilization to a solid surface, without this hindering their biocidal activity.

Unlike the biocidal agents based on gold nanoparticles disclosed in the state of the art, which are ineffective or show only immediate efficacy, the semiconductor metal oxide nanoparticles comprising the metal nanoparticles stabilized with a salt of a cationic compound capable of absorbing visible light such as crystal violet show both: i) high immediate broad spectrum biocidal activity and ii) expected prolonged remnant broad spectrum biocidal activity. Said double biocidal efficacy allows reducing the cleaning procedures or re-application of the biocidal agents without compromising hygiene, which is advantageous in terms of a reduction of the economic cost of the hygiene/maintenance procedures.

Furthermore, the metal nanoparticles (MNPs), the semiconductor metal oxide nanoparticles (MONPs) and the functionalised materials as defined herein are stable under normal use and storage conditions which result in a long half-life. Thus, the nanoparticles remain on the treated surface without detaching from it, and in this way, the potential damage to the health of workers after occupational exposure to said surfaces (containing the nanoparticles) is greatly reduced.

Thus, a first aspect of the invention relates to a metal nanoparticle (MNP) which comprises a metal and a capping agent coordinated to the metal, wherein the capping agent is a salt of a cationic compound capable of absorbing visible light.

A second aspect of the invention relates to a semiconductor metal oxide nanoparticle (MONP) comprising a semiconductor metal oxide core which is covalently attached to a plurality of linkers, wherein one or more of the said linkers are coordinated to one or more of the metal nanoparticles (MNPs) as defined in the first aspect.

A third aspect of the invention relates to a functionalised material which comprises a plurality of semiconductor metal oxide nanoparticles (MONPs), wherein the semiconductor metal oxide nanoparticles comprise a semiconductor metal oxide core which is covalently attached to a plurality of linkers, wherein one or more of the said linkers are further coordinated to one or more of the metal nanoparticles (MNPs) as defined in the first aspect, and one or more of the said linkers different from the linkers coordinated to the metal nanoparticles are further covalently attached to the surface of the material.

A fourth aspect of the invention relates to a photocatalytic paint which comprises the semiconductor metal oxide nanoparticles (MONPs) of the second aspect, or the functionalised material as defined in the third aspect.

A fifth aspect of the invention relates to the use of the semiconductor metal oxide nanoparticles (MONPs) of the second aspect, or alternatively of the functionalised material as defined in the third aspect, as biocides, particularly, for the treatment and/or prevention of a viral disease or a bacterial infection.

A sixth aspect of the invention relates to the use of the semiconductor metal oxide nanoparticles (MONPs) of the second aspect, or the functionalised material as defined in the third aspect, as biocidal agent, as disinfectant agent, or as antiseptic agent.

A seventh aspect of the invention relates to a method for disinfecting comprising applying an appropriate amount of the semiconductor metal oxide nanoparticles (MONPs) as defined in the second aspect, or alternatively the functionalised material as defined in the third aspect, to a solid surface.

Furthermore, the photocatalysts of the invention are also useful for removing pollutants, such as Volatile Organic Compounds (VOCs), from of air and water supplies by photocatalytic degradation resulting in purified air or water and environmentally innocuous waste by-products. Thus, an eighth aspect of the invention relates to the use of the semiconductor metal oxide nanoparticles (MONPs) of the second aspect, or the functionalised material as defined in the third aspect for removing Volatile Organic Compounds (VOCs) from of air and water supplies.

Finally, the photocatalysts of the invention may also be used in the production of hydrogen through water splitting processes. Accordingly, a ninth aspect of the invention relates to the use of the semiconductor metal oxide nanoparticles (MONPs) of the second aspect, or the functionalised material as defined in the third aspect, as a photocatalyst for water splitting.

### BRIEF DESCRIPTION OF THE FIGURES

FIG. 1 shows the synthesis of APTES-TIO₂.

FIG. 2 shows the synthesis of the comparative conjugate APTES-TiO₂@M(2).

FIG. 3 shows the synthesis of Cit/AuNPs/APTES-TiO₂.

FIG. 4 shows the synthesis of the comparative conjugate Cit/AuNPs/APTES-TiO₂@M(4).

FIG. 5 shows the one pot synthesis of CV/AuNPs/APTES-TiO₂ according to the invention.

FIG. 6 shows the synthesis of the conjugate CV/AuNPs/APTES-TiO₂@M(5).

FIG. 7 shows the UV-vis absorbance spectra of the conjugate CV/AuNPs/APTES-TiO₂ in solution.

FIG. 8 shows the synthesis of CV/AuNPs according to the invention.

FIG. 9 shows the synthesis of CV+Cit/AuNPs/APTES-TiO₂.

FIG. 10 shows the synthesis of the comparative conjugate CV+Cit-AuNPs/APTES-TiO₂@M(6).

FIG. 11 shows the infectivity of Human coronavirus HuCoV-229E for CV/AuNPs/APTES-TiO₂@M(5) with respect to control under dark conditions (columns a), and after 4 hours of light exposure (columns b and c).

FIG. 12 shows the infectivity of Human coronavirus HuCoV-229E (Log₁₀TCID₅₀/reaction) for different samples with respect to control under dark conditions.

FIG. 13 shows the infectivity of Human coronavirus HuCoV-229E (Log₁₀TCID₅₀/reaction) for different samples with respect to control after 30 min (A), 60 min (B), and 240 min (C) of light exposure.

FIG. 14 shows the bacterial growth for different conjugates (CV/AuNPs/APTES-TiO₂@PP8-5.5 mg/cm² (7) and CV/AuNPs/APTES-TiO₂@PP8-0.1 mg/cm² (7′)) relative to their control (PP8) after 6 h and 24 h of light exposure. Different letters indicate significant differences.

FIG. 15 shows the UV—vis absorbance spectra of the conjugate CV/AuNPs/APTES-ZnO in solution.

FIG. 16 shows the UV—vis absorbance spectra of the conjugate MB/AuNPs/APTES-TiO₂ in solution.

FIG. 17 shows the UV—vis absorbance spectra of the conjugate MB/AuNPs/APTES-ZnO in solution.

### DETAILED DESCRIPTION OF THE INVENTION

All terms as used herein in this application, unless otherwise stated, shall be understood in their ordinary meaning as known in the art. Other more specific terms as used in the present application are as set forth below and are intended to apply uniformly throughout the specification and claims unless an otherwise expressly set out definition provides a broader definition.

For the purposes of the present invention, all given ranges include both the lower and the upper endpoints of the range. Ranges given, such as temperatures, times, weights, and the like, should be considered approximate, unless specifically stated.

The term “photosensitizer” as used herein refers to a salt of a cationic compound that can be activated by visible light obtaining a higher energy level and is able to transfer this energy to another material, e.g., semiconductor metal oxide, making this material more sensitive to light. In the present invention the photosensitizer also acts as stabilizing agent and controls the growth of the nanoparticle.

For the purposes of the invention, the term “conjugated double bond” denominates two or more double bonds in a molecule which are not separated by CH₂ groups or other structural moieties, i.e., alternating double and single bonds. This alternative nature of bond allows the delocalization of electrons over the whole system and thus, the electrons can be shared by many atoms present in the whole system.

As mentioned above, a first aspect of the present invention refers to a metal nanoparticle (MNP) which comprises a metal and a capping agent coordinated to the metal, wherein the capping agent is a salt of a cationic compound capable of absorbing visible light. The first aspect may also be formulated as the provision of a metal nanoparticle stabilized with a cationic compound capable of absorbing visible light.

For the purposes of the invention, the term “nanoparticles” or its abbreviation “NPs” are used interchangeably and refer to particles having nanoscale dimensions, i.e., having a diameter of from 5 to 500 nm, and having any shape, or morphology. As used herein, the term nanoparticle may include spherical nanoparticles as well as non-spherical nanoparticles. Non-limiting examples of metal nanoparticle forms include nanospheres, nanostars, nanodumbells, nanotubes, nanoshells, nanorods, nanocages, nano-half-shells, nanodomes and nanopyramids.

The term “nanoshell” is a type of nanoparticle characterized by a discrete core-shell structure in which the shell surrounds at least a portion of a core. The core of the nanoshell may be hollow (i.e., empty or filled with a gas) or it may be filled with a liquid (aqueous, oil, etc.) or a solid (i.e., polymer) different from that of the shell. The term “nanospheres” refers to a type of nanoparticles characterized by a solid structure with spherical or quasi-spherical shape. The term “nanorods” refers to a type of nanoparticles characterized by a solid structure and an anisotropic rod-like shape with longitudinal and transversal axes of different length.

In one embodiment, optionally in combination with one or more features of the various embodiments described above or below, the metal nanoparticles of the invention are in a form selected from the group consisting of nanospheres, nanoshells, and nanorods, more particularly, the metal nanoparticles of the invention are nanospheres.

The metal nanoparticles (MNPs) of the first aspect comprise a metal. Non-limiting examples of metals include gold, platinum, silver, palladium, osmium, ruthenium, rhodium, rhenium, molybdenum, copper, iron, nickel, tin, beryllium, cobalt, antimony, chromium, manganese, zirconium, tin, zinc, tungsten, titanium, vanadium, lanthanum, cerium, an alloy thereof, an oxide thereof, and a mixture thereof.

In one embodiment, optionally in combination with one or more features of the various embodiments described above or below, in the metal nanoparticles of the invention the metal is selected from the group consisting of gold, platinum, palladium, silver, copper, aluminium, an alloy thereof, an oxide thereof, and a mixture thereof. In a more particular embodiment, the metal is gold, or an alloy thereof, or an oxide thereof, or a mixture of any of them, even more particularly, the metal is gold. In another more particular embodiment, the metal is silver, or an alloy thereof, or an oxide thereof, or a mixture of any of them, even more particularly, the metal is silver.

In another embodiment, optionally in combination with one or more features of the various embodiments described above or below, the metal is selected from the group consisting of gold, platinum, silver, palladium, osmium, ruthenium, rhodium, rhenium, molybdenum, copper, iron, nickel, tin, beryllium, cobalt, antimony, chromium, manganese, zirconium, tin, zinc, tungsten, titanium, vanadium, lanthanum, cerium, and a mixture thereof.

In another embodiment, optionally in combination with one or more features of the various embodiments described above or below, the oxidation state of the metal nanoparticles (MNPs) of the first aspect is zero.

The metal nanoparticles of the first aspect further comprise a capping agent coordinated to the metal. For the purposes of the invention, the term “coordinated” refers to the fact that the capping agent and the metal are in direct physical or electrical contact or are not in direct contact with each other, but yet still interact with each other.

The term “capping agent” refers to an agent which acts as stabilizing agent providing colloidal stability along with preventing agglomeration and stopping uncontrolled growth, enabling particle size control during production and reducing particles' surface oxidation or other contamination. The capping agent is capable of coordinating (and interacting) with a metal atom of the nanoparticle (i.e., the capping agent is coordinated to the metal). In the present invention, the capping agent is a constitutional element of the nanoparticles. Therefore, the capped or stabilized metal nanoparticles (MNPs) of the present invention (i.e., metal nanoparticles stabilized with a capping agent which is a salt of a cationic compound capable of absorbing visible light) have to be distinguished from those not forming part of the present invention, wherein a salt of a cationic compound capable of absorbing visible light is adsorbed on the surface of the nanoparticles as a coating after the nanoparticles have been already formed using another chemical compound as stabilizer or capping agent such as citric acid, citrate, or a mixture thereof.

As mentioned above, the metal nanoparticles (MNPs) of the present invention comprise one or more capping agents which are salts of cationic compounds capable of absorbing visible light (photosensitizers). In one embodiment, optionally in combination with one or more features of the various embodiments described above or below, the salt of the cationic capping agent is capable of absorbing visible light from 400 nm to 800 nm.

In another embodiment, optionally in combination with one or more features of the various embodiments described above or below, the metal nanoparticles (MNPs) of the present invention comprise a single capping agent which is a salt of a cationic compound capable of absorbing visible light.

In another embodiment, optionally in combination with one or more features of the various embodiments described above or below, the one or more salts of cationic compounds capable of absorbing visible light are compounds having one or more conjugated double bonds.

In another embodiment, optionally in combination with one or more features of the various embodiments described above or below, the salts of cationic compounds capable of absorbing visible light are compounds having one or more aromatic rings which may be optionally fused.

In another embodiment, optionally in combination with one or more features of the various embodiments described above or below, the salt of the cationic compound capable of absorbing visible light is selected from the group consisting of an ammonium salt, a sulfonium salt, a phosphonium salt, and a mixture thereof. In a more particular embodiment, the salt of the cationic compound capable of absorbing visible light is selected from the group consisting of an ammonium salt. In another more particular embodiment, the salt of the cationic compound capable of absorbing visible light is a sulfonium salt.

In another embodiment, optionally in combination with one or more features of the various embodiments described above or below, the salt of the cationic compound capable of absorbing visible light is a salt of a cation selected from the group consisting of 4-{bis[4-(dimethylamino)-phenyl]methylidene}-N, N-dimethylcyclohexa-2,5-dien-1-iminiumM (7-amino-8-methylphenothiazin-3-ylidene)-dimethylammonium; 3,7-bis(dimethylamino)-phenothiazin-5-ium; and 4-{[4-(dimethylamino)phenyl]-(phenyl)methylidene}-N,N-dimethylcyclohexa-2,5-dien-1-iminium.

In the salts of the cationic compound capable of absorbing visible light any suitable inorganic or organic anions may be used. Non-limiting examples of anions that may be used include carbonate, hydrogen carbonate, sulfate, hydrogen sulfate, phosphate, hydrogen phosphate, dihydrogen phosphate, halides (such as fluoride, chloride, bromide, iodide), oxalate, formate, acetate, propanoate, butanoate, pentanoate, tartrate, malate, pyruvate, oxalate, succinate, citrate, fumarate, nitrate, hydroxide, oxalate, sulfonate, and the like.

In one embodiment, optionally in combination with one or more features of the various embodiments described above or below, the salt of the cationic compound capable of absorbing visible light comprises an inorganic anion. More particularly, the anion is a halide, even more particularly fluoride, chloride, bromide, or iodide, and even more particularly is chloride.

In another embodiment, optionally in combination with one or more features of the various embodiments described above or below, the salt of the cationic compound capable of absorbing visible light comprises an organic anion. More particularly, the anion is oxalate.

According to another embodiment, optionally in combination with one or more features of the various embodiments described above or below, the salt of the cationic compound capable of absorbing visible light is selected from the group consisting of crystal violet, toluidine blue, methylene blue, malachite green, and mixtures thereof.

In one embodiment, optionally in combination with one or more features of the various embodiments described above or below, the salt of the cationic compound capable of absorbing visible light is crystal violet. For the purposes of the invention, the terms “crystal violet”, “gentian violet”, “methyl violet 10B” and “hexamethyl pararosaniline chloride” have the same meaning and they are used interchangeably. Crystal violet is also known as 4-{Bis[4-(dimethylamino)-phenyl]methylidene}-N, N-dimethylcyclohexa-2,5-dien-1-iminium chloride (CAS number 548-62-9, CAS number of the free base: 1733-13-7). The crystal violet has the following formula:

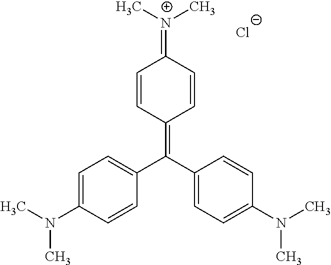

In another embodiment, optionally in combination with one or more features of the various embodiments described above or below, the salt of the cationic compound capable of absorbing visible light is toluidine blue. For the purposes of the invention, the terms “toluidine blue”, “tolonium chloride”, “TBO” and “toluidine blue O” have the same meaning and they are used interchangeably. Toluidine blue is also known as (7-amino-8-methylphenothiazin-3-ylidene)-dimethylammonium chloride (CAS number 92-31-9). The toluidine blue has the following formula:

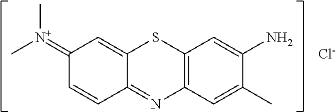

In another embodiment, optionally in combination with one or more features of the various embodiments described above or below, the salt of the cationic compound capable of absorbing visible light is methylene blue. For the purposes of the invention, the terms “methylene blue”, “methylthioninium chloride”, “CI 52015” and “basic blue 9” have the same meaning and they are used interchangeably. Methylene blue is also known as 3,7-bis(dimethylamino)-phenothiazin-5-ium chloride (CAS number 61-73-4). The methylene blue has the following formula:

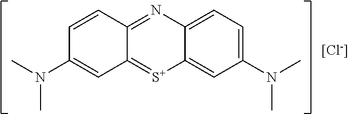

In another embodiment, optionally in combination with one or more features of the various embodiments described above or below, the salt of the salt of the cationic compound capable of absorbing visible light is malachite green. For the purposes of the invention, the terms “malachite green”, “Aniline green”, “Basic green 4”, “Diamond green B”, and “Victoria green B”, have the same meaning and they are used interchangeably. Malachite green is also known as 4-{[4-(dimethylamino)phenyl]-(phenyl)methylidene}-N,N-dimethylcyclohexa-2,5-dien-1-iminium chloride (CAS number 569-64-2; CAS number of the oxalate salt 2437-29-8). The malachite green has the following formula:

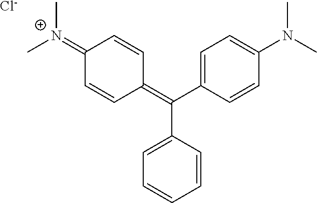

According to one embodiment, optionally in combination with one or more features of the various embodiments described above or below, the weight percentage of the capping agent is from 2 to 20% by weight of the total weight of the nanoparticle, more particularly, is from 3 to 15%, and even more particularly from 5 to 10% by weight of the total weight of the nanoparticle. In another embodiment, optionally in combination with one or more features of the various embodiments described above or below, the weight percentage of the capping agent is about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20%, by weight of the total weight of the nanoparticle. The terms “percentage (%) by weight”, “weight/weight %” and “w/w %” have the same meaning and are used interchangeably. They refer to the percentage of each ingredient of the nanoparticle in relation to the total weight of the nanoparticle.

In another embodiment, optionally in combination with one or more features of the various embodiments described above or below, the metal nanoparticles of the present invention have an average particle size from 1.5 to 10 nm measured by TEM, more particularly, the metal nanoparticles have an average particle size from 2 to 8 nm, and even more particularly from 3 to 6 nm measured by TEM. In another embodiment, optionally in combination with one or more features of the various embodiments described above or below, the metal nanoparticles have an average particle size about 1.5, about 2, about 2.5, about 3, about 3.5, about 4, about 4.5, about 5, about 5.5, about 6, about 6.5, about 7, about 7.5, about 8, about 8.5, about 9, about 9.5, or about 10 nm measured by TEM.

The terms “particle size” and “average particle size” are used herein interchangeably and refer to the size of the particles measured in nm. The measurement may be performed with an appropriate apparatus by conventional analytical techniques such as, for example, microscopic determination utilizing a scanning electron microscope (SEM) or transmission electron microscope (TEM), using Image J software.

In another embodiment, optionally in combination with one or more features of the various embodiments described above or below, the metal nanoparticles of the present invention have an average particle size distribution from 0.5 to 1.5 nm or from 0.5 to 2.0 nm, in particular measured by TEM, more particularly, the metal nanoparticles have an average particle size distribution about 0.5, about 0.6, about 0.7, about 0.8, about 0.9, about 1.0, about 1.1, about 1.2, about 1.3, about 1.4, about 1.5, about 1.6, about 1.7, about 1.8, about 1.9, or about 2.0. The terms “particle size distribution” or “PSD” have the same meaning and are used interchangeably. They refer to the distribution of sizes for the particles prepared. In the present invention the particle size distribution was calculated with the Origin Lab® software fitting a Gaussian function.

According to one embodiment, optionally in combination with one or more features of the various embodiments described above or below, the metal nanoparticles comprise
a) a metal which is gold, an alloy thereof, an oxide thereof, or a mixture of any of them, particularly gold; and
b) a capping agent coordinated to the metal, wherein the capping agent is a salt of a cationic compound capable of absorbing visible light, which is selected from the group consisting of crystal violet, toluidine blue, methylene blue, malachite green, and mixtures thereof, particularly the capping agent is crystal violet. More particularly, in the above embodiment, the metal nanoparticles are nanospheres having an average particle size from 1.5 to 10 nm, and an average particle size distribution from 0.5 to 1.5 nm measured by TEM, and the capping agent is present in an amount from 2 to 20% by weight of the total weight of the nanoparticle.

The metal nanoparticles of the first aspect may be prepared by methods well known in the art using a salt of a cationic compound capable of absorbing visible light as a capping agent. Thus, it also forms part of the present invention a process for the preparation of the metal nanoparticles of the first aspect which comprises converting HₓMX_{y} into M(0) in the presence of a base, a reducing agent, and a capping agent which is a salt of a cationic compound capable of absorbing visible light, wherein x is an integer from 0 to 2; y is an integer from 4 to 6; X is halogen (particularly selected from F, Cl, Br, I, and At) or acetate; and M is metal as defined herein.

When the precursor HₓMX_{y} is not commercially available, the precursor solution may be synthesized using the common deposition-precipitation method through an MX_{y} solution in the corresponding acid solution.

The present invention also relates to the metal nanoparticles of the first aspect are obtainable by a process which comprises converting HₓMX_{y} into M(0) in the presence of a base, a reducing agent, and a capping agent which is a salt of a cationic compound capable of absorbing visible light, wherein x is an integer from 0 to 2; y is an integer from 4 to 6; X is halogen (particularly selected from F, Cl, Br, I, and At) or acetate; and M is metal as defined herein.

The expression “obtainable” as defined above is used herein to define the product by its preparation process. For the purposes of the invention the expressions “obtainable”, “obtained” and equivalent expressions are used interchangeably, and in any case, the expression “obtainable” encompasses the expression “obtained”.

In one embodiment, optionally in combination with one or more features of the various embodiments described above or below, in the process for the preparation of the metal nanoparticles of the first aspect, HₓMX_{y} is HMCl₄, wherein more particularly M is gold or silver.

In another embodiment, optionally in combination with one or more features of the various embodiments described above or below, in the process for the preparation of the metal nanoparticles (MNPs) of the first aspect, the base is selected from the group consisting of an alkali hydroxide, an alkaline earth hydroxide and ammonia; more particularly the base is an alkali hydroxide, even more particularly sodium hydroxide.

In another embodiment, optionally in combination with one or more features of the various embodiments described above or below, in the process for the preparation of the metal nanoparticles (MNPs) of the first aspect, the reducing agent is a hydrazine compound (such as hydrazine or phenylhydrazine), an alkali metal borohydride (such as sodium borohydride, NaBH₄) or diol compound (such as hydroquinone, catechol, and ethylene glycol). More particularly, the reducing agent is a diol compound, even more particularly is ethylene glycol.

In another embodiment, optionally in combination with one or more features of the various embodiments described above or below, the process for the preparation of the metal nanoparticles (MNPs) of the first aspect is performed at a temperature from 15 to 26° C. or from 15 to 35° C., more particularly from 20 to 26° C. or from 20 to 30° C.

A mentioned above, the second aspect of the invention relates to a semiconductor metal oxide nanoparticle (MONP) comprising a semiconductor metal oxide core which is covalently attached to a plurality of linkers, wherein one or more of the said linkers are coordinated to one or more of the metal nanoparticles (MNPs) as defined in the first aspect.

In one embodiment, optionally in combination with one or more features of the various embodiments described above or below, the semiconductor metal oxide nanoparticles (MONPs) of the invention are in a form selected from the group consisting of nanospheres, nanoshells, and nanorods, more particularly, the semiconductor metal oxide nanoparticles of the invention are nanospheres.

The term “semiconductor metal oxide” as used herein refers to a metal oxide that exhibits capability to generate charge carriers when stimulated with required amount of light energy. Non-limiting examples of semiconductor metal oxides include TiO₂, ZnO, SnO₂, Nb₂O, In₂O₃, WO₃, Fe₂O₃, Co₃O, CuO and RuO₂.

According to one embodiment, optionally in combination with one or more features of the various embodiments described above or below, the semiconductor metal oxide is selected from the group consisting of TiO₂, ZnO, SnO₂, Nb₂O, In₂O₃, WO₃, Fe₂O₃, Co₃O, CuO, RuO₂, and combinations thereof. More particularly, the semiconductor metal oxide is titanium oxide or zinc oxide.

In another embodiment, optionally in combination with one or more features of the various embodiments described above or below, the semiconductor metal oxide nanoparticles of the present invention have an average particle size equal to or lower than 100 nm, more particularly, from 15 to 50 nm measured by TEM. In another embodiment, optionally in combination with one or more features of the various embodiments described above or below, the metal nanoparticles have an average particle size about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, about 95 nm or about 100 nm measured by TEM.

In another embodiment, optionally in combination with one or more features of the various embodiments described above or below, the weight percentage of the metal of the nanoparticles stabilized with the cationic compound capable of absorbing visible light (i.e. nanoparticles ii), particularly gold or silver, is from 5 to 25%, more particularly from 7 to 15%, of the total weight of the semiconductor metal oxide nanoparticle (MONP), more particularly is about 5%, about 6%, about 7%, about 8%, about 8.5%, about 9%, about 9.5%, about 10%, about 15%, about 20%, or about 25% of the total weight of the semiconductor metal oxide nanoparticle (MONP).

In another embodiment, optionally in combination with one or more features of the various embodiments described above or below, the weight percentage of the linkers is equal to or lower than 10%, more particularly from 2 to 10%, of the total weight of the semiconductor metal oxide nanoparticle (MONP), more particularly is about 0.5%, about 1%, about 2%, about 3%, about 4%, about 5%, about 6%, about 7%, about 8%, about 9%, or about 10% of the total weight of the semiconductor metal oxide support nanoparticle (MONP).

The linkers in the semiconductor metal oxide nanoparticles (MONPs) are bifunctional moieties which are covalently attached to semiconductor metal oxide core. Besides, one or more of the said linkers are coordinated to one or more of the metal nanoparticles (MNPs) thereby immobilizing the MNPs onto MONPs.

In another embodiment, optionally in combination with one or more features of the various embodiments described above or below, the linkers have the formula (I):

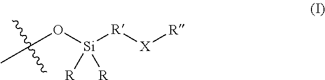

wherein:
each R independently is —(C₁-C₆)alkyl or —O(C₁-C₆)alkyl,
R′ is selected from the group consisting of —(CH₂)ₙ—, —CH(YH)—(CH₂)ₙ—, —(CH₂)ₙ—Y—(CH₂)ₘ—, and —(CH₂)ₙ—Y—(CH₂)ₘ—Y′—(CH₂)ₚ—,
n, m and p are integers from 1 to 6,
X, Y, and Y′ are selected from the group consisting of —O—, —S— and —NH—,
R″ is —H or —(C₁-C₃)alkyl, and
the wavy line represents the attachment point to the semiconductor metal oxide nanoparticle core.

For the purposes of the invention, the term “(C₁-C₆)alkyl” refers to a linear or branched saturated hydrocarbon group having from 1 to 6 carbon atoms. By way of example, mention may be made of methyl, ethyl, propyl, isopropyl, butyl, isobutyl, sec-butyl, or tert-butyl, n-pentyl or n-hexyl groups and the like.

In the above embodiment, when the semiconductor metal oxide is TiO₂, the linkers of formula (I) are attached to the semiconductor metal oxide nanoparticles (MONPs) through Si—O—Ti covalent bonds and when the semiconductor metal oxide is ZnO, the linkers are attached to the semiconductor metal oxide nanoparticles (MONPs) through Si—O—Zn covalent bonds. Further, one or more of these linkers are coordinated to the metal nanoparticles (MNPs).

In another embodiment, optionally in combination with one or more features of the various embodiments described above or below, the linkers in the semiconductor metal oxide nanoparticle are linkers of formula (I) wherein R is selected from the group consisting of methoxy, ethoxy, and methyl.

In another embodiment, optionally in combination with one or more features of the various embodiments described above or below, the linkers in the semiconductor metal oxide nanoparticle are linkers selected from the following linkers of formula (I):
a) each R is methoxy, R′ is —(CH₂)₃—, X is —NH—, and R″ is —H;
b) each R is methoxy, R′ is —(CH₂)₃—, X is —O—, and R″ is —H;
c) each R is methoxy, R′ is —(CH₂)₃—, X is —S—, and R″ is —H;
d) each R is methoxy, R′ is —CH(OH)—(CH₂)—, X is —O—, and R″ is —H;
e) each R is methoxy, R′ is —CH(SH)—(CH₂)—, X is —S—, and R″ is —H;
f) each R is methoxy, R′ is —(CH₂)₃—, X is —NH—, and R″ is methyl;
g) each R is ethoxy, R′ is —(CH₂)₃—, X is —NH—, and R″ is —H;
h) each R is ethoxy, R′ is —(CH₂)₃—, X is —O—, and R″ is —H;
i) each R is ethoxy, R′ is —(CH₂)₃—, X is —S—, and R″ is —H;
j) each R is ethoxy, R′ is —(CH₂)₂—, X is —O—, and R″ is —H;
k) each R is ethoxy, R′ is —(CH₂)₂—, X is —S—, and R″ is —H;
I) each R is methyl, R′ is —(CH₂)₃—, X is —NH—, and R″ is —H;
m) one R is methyl, one R is ethoxy, R′ is (CH₂)₃—, X is —NH—, and R″ is —H;
n) one R is methyl, one R is methoxy, R′ is (CH₂)₃—, X is —O—, and R″ is —H;
o) one R is methyl, one R is methoxy, R′ is (CH₂)₃—, X is —S—, and R″ is —H;
p) each R is methoxy, R′ is —(CH₂)₃—NH—(CH₂)₂—, X is —NH—, and R″ is —H; and
q) each R is methoxy, R′ is —(CH₂)₃—NH—(CH₂)₂—NH—(CH₂)₂—, X is —NH—, and R″ is —H.

In another embodiment, optionally in combination with one or more features of the various embodiments described above or below, the linkers in the semiconductor metal oxide nanoparticle are linkers of formula (I), wherein each R is ethoxy, R′ is —(CH₂)₃—, X is —NH—, and R″ is —H.

According to one embodiment, optionally in combination with one or more features of the various embodiments described above or below, the semiconductor metal oxide nanoparticles (MONP), particularly having an average particle size equal to or lower than 100 nm measured by TEM, comprise a semiconductor metal oxide core, particularly a titanium oxide core, which is covalently attached to a plurality of linkers, more particularly linkers of formula (I), even more particularly linkers of formula (I), wherein each R is ethoxy, R′ is —(CH₂)₃—, X is —NH—, and R″ is —H; wherein one or more of the said linkers are coordinated to one or more of the metal nanoparticles (MNPs) as defined in the first aspect. Particularly, in this embodiment, the weight percentage of the metal of the nanoparticles is from 5 to 25% of the total weight of the semiconductor metal oxide nanoparticle (MONP), and the weight percentage of the linkers is equal to or lower than 10% of the total weight of the semiconductor metal oxide nanoparticle (MONP).

More particularly, the semiconductor metal oxide nanoparticles, particularly having an average particle size equal to or lower than 100 nm measured by TEM, comprise a semiconductor metal oxide core, particularly a titanium oxide core, which is covalently attached to a plurality of linkers, more particularly linkers of formula (I), even more particularly linkers of formula (I), wherein each R is ethoxy, R′ is —(CH₂)₃—, X is —NH—, and R″ is —H; wherein one or more of the said linkers are coordinated to one or more of the metal nanoparticles which comprise:
a) a metal which is gold, an alloy thereof, an oxide thereof, or a mixture of any of them, particularly gold; and
b) a capping agent coordinated to the metal, wherein the capping agent is a salt of a cationic compound capable of absorbing visible light, which is selected from the group consisting of crystal violet, toluidine blue, methylene blue, malachite green, and mixtures thereof, particularly the capping agent is crystal violet, wherein more particularly, the metal nanoparticles are nanospheres having an average particle size from 1.5 to 10 nm, and an average particle size distribution from 0.5 to 1.5 nm measured by TEM, and the capping agent is present in an amount from 2 to 20% by weight of the total weight of the nanoparticle. Particularly, in this embodiment, the weight percentage of the metal of the nanoparticles is from 5 to 25% of the total weight of the semiconductor metal oxide nanoparticle, and the weight percentage of the linkers is equal to or lower than 10% of the total weight of the semiconductor metal oxide nanoparticle.

The solid supported nanoparticles of the second aspect comprising the metal nanoparticles of the first aspect may be prepared by methods well known in the art, in particular by a polyol-assisted reduction process.

Thus, it also forms part of the present invention a process for the preparation of the semiconductor metal oxide nanoparticles (MONPs) of the second aspect which comprises:
a) providing semiconductor metal oxide nanoparticles functionalized with a linker which is capable of coordinating to one or more of the metal nanoparticles (MNPs) as defined in the first aspect; and
b) converting HₓMX_{y} into M(0) in the presence of a base, a reducing agent, a capping agent which is a salt of a cationic compound capable of absorbing visible light, and the functionalized semiconductor metal oxide nanoparticles of step a);
wherein x is an integer from 0 to 2; y is an integer from 4 to 6; X is halogen (particularly selected from F, Cl, Br, I, and At) or acetate; and M is metal as defined herein.

The present invention also relates to the semiconductor metal oxide nanoparticles (MONPs) of the second aspect obtainable by a process which comprises:
a) providing semiconductor metal oxide nanoparticles functionalized with a linker which is capable of coordinating to one or more of the nanoparticles as defined in the first aspect; and
b) converting HₓMX_{y} into M(0) in the presence of a base, a reducing agent, a capping agent which is a salt of a cationic compound capable of absorbing visible light, and the functionalized semiconductor metal oxide nanoparticles of step a);
wherein x is an integer from 0 to 2; y is an integer from 4 to 6; X is halogen (particularly selected from F, Cl, Br, I, and At) or acetate; and M is metal as defined herein.

In one embodiment, optionally in combination with one or more features of the various embodiments described above or below, the semiconductor metal oxide nanoparticles functionalized with a linker of step a) may be obtained by reacting semiconductor metal oxide nanoparticles with a linker at a temperature from 15 to 26° C. or from 15 to 35° C., more particularly from 20 to 26° C. or from 20 to 30° C., optionally in the presence of a suitable solvent, such as e.g., ethanol.

The semiconductor metal oxide nanoparticles are commercially available or alternatively can be prepared by methods well-known in the art.

According to one particular embodiment, optionally in combination with one or more features of the various embodiments described above or below, the linker of step a) is an organosilane comprising at least a terminal group selected from a quaternary ammonium group, a hydroxy group, or a thiol group. Thus, the organosilane may be an aminosilane, an hydroxysilane or a thiosilane, respectively. The terminal groups are capable to electrostatically interact with the metal nanoparticles of the first aspect of the invention. Organosilanes may be obtained by processes well-known in the art.

Non-limiting examples of available aminosilanes include 3-aminopropyltrimethoxysilane (APTMS), 3-aminopropyltriethoxysilane (APTES), 3-(2-aminoethylamino) propyltrimethoxy-silane (AAPTS), (3-aminopropyl)dimethylethoxysilane (APMES), (3-aminopropyl)-diethoxymethylsilane (APDEMS), 3-[2-(2-aminoethylamino)ethylamino]propyltrimethoxy-silane, or trimethoxy[3-(methylamino)propyl]silane (MAPTMS). Non limiting examples of hydroxysilanes include 3-hydroxypropyltrimethoxysilane, 3-hydroxypropyltriethoxysilane, 3-hydroxypropylmethyldimethoxysilane, 2-hydroxyethyltriethoxysilane, and 1,2-dihydroxyethyltrimethoxysilane. Non limiting examples of thiosilanes (also known as mercaptosilanes) include 3-mercaptopropyltrimethoxysilane, 3-mercaptopropyl-triethoxysilane, 3-mercaptopropylmethyldimethoxysilane, 2-mercaptoethyltriethoxysilane, and 1,2-dimercaptoethyltrimethoxysilane.

According to one particular embodiment, optionally in combination with one or more features of the various embodiments described above or below, the linker of step a) has the formula (II):

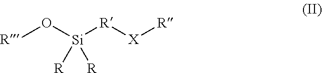

wherein:
each R independently is —(C₁-C₆)alkyl or —O(C₁-C₆)alkyl,
R′ is selected from the group consisting of —(CH₂)ₙ—, —CH(YH)—(CH₂)ₙ—, —(CH₂)ₙ—Y—(CH₂)ₘ—, and —(CH₂)ₙ—Y—(CH₂)ₘ—Y′—(CH₂)ₚ—,
n, m and p are integers from 1 to 6,
X, Y, and Y′ are selected from the group consisting of —O—, —S— and —NH—,
R″ is —H or —(C₁-C₃)alkyl, and
R′″ is —O(C₁-C₆)alkyl.

In another particular embodiment, optionally in combination with one or more features of the various embodiments described above or below, the linker of step a) has the formula (II), wherein each R is ethoxy, R′ is —(CH₂)₃—, X is —NH—, R″ is —H, and R′″ is ethoxy.

Step b) of the process above can be carried out under the same conditions disclosed for the process of the preparation of the metal nanoparticles (MNPs). Thus, the embodiments indicated above for the process of the preparation of the metal nanoparticles also apply to the process for the preparation of the solid supported nanoparticles.

A mentioned above, the third aspect of the invention relates to a functionalised material which comprises a plurality of semiconductor metal oxide nanoparticles (MONPs), wherein the semiconductor metal oxide nanoparticles comprise a semiconductor metal oxide core which is covalently attached to a plurality of linkers, wherein one or more of the said linkers are further coordinated to one or more of the metal nanoparticles (MNPs) as defined in the first aspect, and one or more of the said linkers different from the linkers coordinated to the metal nanoparticles are further covalently attached to the surface of the material.

In another embodiment, optionally in combination with one or more features of the various embodiments described above or below, the weight percentage of the semiconductor metal oxide nanoparticles is equal to or lower than 50%, more particularly from 15 to 35%, of the total weight of the functionalised material, more particularly is about 15%, about 16%, about 17%, about 18%, about 19%, about 20%, about 21%, about 22%, about 23%, about 24%, about 25%, about 26%, about 27%, about 28%, about 29%, about 30%, about 35%, about 40%, about 45%, or about 50% of the total weight of the semiconductor metal oxide nanoparticle.

In another embodiment, optionally in combination with one or more features of the various embodiments described above or below, the weight percentage of the capping agent is from equal to or lower than 1%, more particularly from 0.2 to 1%, of the total weight of the functionalised material, more particularly is about 0.1%, about 0.2%, about 0.3%, about 0.4%, about 0.5%, about 0.6%, about 0.7%, about 0.8%, about 0.9%, or about 1% of the total weight of the semiconductor metal oxide nanoparticle.

The functionalised material of the third aspect comprises one or more functional groups, such as hydroxyl or carboxylate groups, attached to its surface which are capable covalently attached to the linkers of the semiconductor metal oxide nanoparticles (MONPs). Such functional groups may be already present in the material or may be introduced by well-known chemical reactions depending on the functionalization of the linker of the semiconductor metal oxide nanoparticles. For example, a functionalised material comprising carboxylate groups can be reacted with a coupling agent such as e.g., dicyclohexylcarbodiimide (DCC) or diisopropylcarbodiimide (DIC) to form a covalent link with a linker containing for example terminal amino groups (an amide bond).

The functionalised material of the third aspect may be a polymeric material, a mineral material or a glass.

In one embodiment, optionally in combination with one or more features of the various embodiments described above or below, the functionalised material is a mineral material, or a glass. In a more particular embodiment, the mineral material or glass is in the form of a sheet.

In another embodiment, optionally in combination with one or more features of the various embodiments described above or below, the functionalised material is a polymeric material. The polymeric material may be a bio-based polymer, such as a polysaccharide-based polymer with semi-crystalline or amorphous structure, belonging to the biopolyester family. Non-limiting examples of such biopolyesters are polyhydroxyalkanoate (PHA) or Polybutylene succinate (PBS). A petrochemical-based thermoplastic polymer, semi-crystalline or amorphous, belonging to the thermoplastic rubber or polyolefin family can also be used. Non-limiting examples of such rubber include thermoplastic polyurethane (TPU) and non-limiting examples of such polyolefins include low density polyethylene (LDPE), high density polyethylene (HDPE) or polypropylene (PP). In another embodiment, optionally in combination with one or more features of the various embodiments described above or below, the functionalised material is polypropylene/Na-alginate. In a more particular embodiment, the polymeric material is in the form of a film. In another more particular embodiment, the polymeric material is in the form of beads of micrometric size. For the purposes of the invention, the term micrometric size refers to a size of equal to or less than 200 μm, particularly equal to or less than 100 μm. The term “beads” as used herein, refers to a morphology which is typically spherical or near spherical.

In one more particular embodiment, optionally in combination with one or more features of the various embodiments described above or below, the beads of the functionalised material of the third aspect have a particle size distribution D90 from 2 to 80 μm, in particular measured as defined herein. The term “D90” refers to the value of particle size distribution where at least 90% of the beads have a size lower than or equal to that value. A D90 from 2 to 80 μm means that 90% of the beads have a diameter within this range, and 10% of the beads have a diameter which is either below 2 μm or above 80 μm. The average size of the beads can be measured using a “Image-ProPlus 5” or Image J software and the OM micrographs of the beads. The size distribution can be measured by means of a HELOS BR supplied by Sympatec GmbH System Partikel Technik equipped with a R1 cuvette and a Helium-Neon Laser 5 mW max output at 632.8 nm.

In another more particular embodiment, optionally in combination with one or more features of the various embodiments described above or below, the beads have a particle size distribution D90 from 2 to 80 μm, more particularly from 2 to 55 μm, and even more particularly from 2 to 35 μm.

In another embodiment, optionally in combination with one or more features of the various embodiments described above or below, the functionalised material forms part of an ink or paint to prepare coatings or films onto a surface.

In another embodiment, optionally in combination with one or more features of the various embodiments described above or below, the functionalised material is in the form of beads of micrometric size, wherein the beads are microcapsules of a polysaccharide-based polymer.

For the purposes of the invention, the term “microcapsules” refers to beads having micrometric size. The microcapsules may comprise two differentiated phases: the wall or external phase, and the core, also referred to as nucleus or internal phase, which may comprise one or more active ingredients. When present, the core is encapsulated by the wall. The microcapsule may be formed from a polysaccharide-based polymer, more particularly selected from the groups consisting of alginate, chitosan, carrageenan, gellan gum, dextran, carboxyl methyl cellulose, hyaluronic acid, and a combination thereof, more particularly, the polysaccharide-based polymer is alginate. Examples of commercial alginate derivatives which may be used for the preparation of the microcapsules include sodium alginate Type NA7580 (C.E. Roeper GmbH, Article: 10324), sodium alginate Type NA5030 (C.E. Roeper GmbH, Article: 10323), sodium alginate Type NA4012 (C.E. Roeper GmbH, Article: 10322), sodium alginate Type NA3545 (C.E. Roeper GmbH, Article: 10321), or sodium alginate Type NA1080HG with viscosity (C.E. Roeper GmbH, Article: 10739).

According to one embodiment, optionally in combination with one or more features of the various embodiments described above or below, the microcapsules further comprise one or more multivalent metallic cations, particularly divalent cations selected from the group consisting of C^{a2+}, Mg²⁺, Fe²⁺, and Zn²⁺, more particularly Ca²⁺, in the form of a salt, acting as cross-linking agents. In a more particular embodiment, the microcapsules of the third aspect further comprises one or more multivalent metallic cations. The above-mentioned cations may be present in the form of a chloride, phosphate, carbonate, oxalate, or sulfate salt.

In another embodiment, optionally in combination with one or more features of the various embodiments described above or below, the microcapsules are formed from a polysaccharide-based polymer which is alginate and further comprise calcium chloride.

In another embodiment, optionally in combination with one or more features of the various embodiments described above or below, the functionalised material of the third aspect comprises polypropylene or polyethylene containing alginate or oxalic acid as additives.

The functionalised material of the third aspect may be prepared by methods well known in the art. For example, in the case of polymer microcapsules, these can be prepared using complex coacervation method.

Thus, it also forms part of the present invention a process for the preparation of the functionalised material of the third aspect which comprises:
a) providing a material functionalized with moieties on its surface which are capable to form a covalent bond with the linkers of the semiconductor metal oxide nanoparticles of the second aspect, and
b) contacting the material with the semiconductor metal oxide nanoparticles, such that a covalent link is formed between the material, in particular in the form of beads or a film, and the linkers.

The present invention also relates to the functionalised material of the third aspect obtainable by a process which comprises:
a) providing a material functionalized with moieties on its surface which are capable to form a covalent bond with the linkers of the semiconductor metal oxide nanoparticles of the second aspect, and
b) contacting the material with the semiconductor metal oxide nanoparticles, such that a covalent link is formed between the material, in particular in the form of beads or a film, and the linkers.

The functionalised material used in step a) may already contain the moieties which are capable to form a covalent bond with the linkers. Alternatively, the material can be functionalized by reacting it with a coupling agent. In one embodiment, optionally in combination with one or more features of the various embodiments described above or below, the coupling agent is selected from dicyclohexylcarbodiimide (DCC) or diisopropylcarbodiimide (DIC).

As mentioned above, a further aspect of the disclosure refers to the use of the semiconductor metal oxide nanoparticles (MNOPs) of the second aspect, or alternatively the functionalised material of the third aspect, as biocide, particularly, for the treatment and/or prevention of a viral disease or a bacterial infection. This aspect may also be formulated as a method for the treatment or prevention of a viral disease or a bacterial infection, which comprises administering to a subject in need thereof, including a human, the semiconductor metal oxide nanoparticles (MNOPs) of the second aspect, or alternatively the functionalised material of the third aspect of the invention. It also forms part of the invention the use of the semiconductor metal oxide nanoparticles (MNOPs) of the second aspect, or alternatively the functionalised material of the third aspect of the invention, for the manufacture of the composition for the treatment or prevention of a viral disease or a bacterial infection.

It is also a part of the invention the use of the semiconductor metal oxide nanoparticles (MNOPs) of the second aspect, or alternatively the functionalised material of the third aspect as biocidal agent. For the purpose of the invention, the terms “biocidal agent” and “biocide active ingredient” have the same meaning and are interchangeably. They refer to such compound capable to exercise a control over a harmful organism such as for example destroying, counteracting, neutralizing, or avoiding the action of said harmful organism. For the purpose, the term “harmful organism” encompasses virucidal compounds, fungicidal compounds, bactericidal compounds, yeasticidal compounds, and sporicidal compounds.

In an embodiment, the semiconductor metal oxide nanoparticles (MNOPs) of the second aspect, or alternatively the functionalised material of the third aspect of the invention are useful as virucidal compound. In another embodiment, the semiconductor metal oxide nanoparticles (MNOPs) of the second aspect, or alternatively the functionalised material of the third aspect of the invention are useful as bactericidal compound.

The use as “biocidal agent” for the present invention encompasses the use as disinfectant and also the use as antiseptic. In an embodiment, the use of the semiconductor metal oxide nanoparticles (MNOPs) of the second aspect, or alternatively the functionalised material of the third aspect of the invention as disinfectant biocidal. The term “disinfectant” refers to a product which is capable of exercise a control over a harmful organism as disclosed herein above on inanimate objects. Examples of inanimate objects include among others hard surfaces (such as medical devices and surgical equipment); air (medical and surgical rooms, and air-conditioning or air heating systems); and liquid media (water purification systems for domestic use (air conditioning and heating pumps, showers, and pools, and drinking water) and ornamental (fountains and ponds). In an embodiment, the use of the semiconductor metal oxide nanoparticles (MNOPs) of the second aspect, or alternatively the functionalised material of the third aspect of the invention as antiseptic biocidal. The term “antiseptic” refers to a product which is capable of exercise a control over a harmful organism as disclosed herein above in or on the living tissues of humans or animals such as for example on the skin.

It is also a part of the invention a method for disinfecting comprising applying an appropriate amount of semiconductor metal oxide nanoparticles of the second aspect (MNOPs), or alternatively the functionalised material of the third aspect of the invention, to solid surfaces. The appropriate solid surface and their amounts can readily be determined by those skilled in the art according to the final use the nanoparticles or solid supported nanoparticles of the present invention. Example of appropriate surface include, but not limited to, floors, walls, ceiling, filters, pipes, devices, or other equipment.

These processes can further comprise an additional previous step of pre-treating the metal surface of the nanoparticles of the present invention before contacting the semiconductor metal oxide nanoparticles (MNOPs). Examples of appropriate pre-treatment steps of the metal surface of the nanoparticles of the present invention include, but is not limited to, passivation, piranha or by the treatment with one or more alkali solution(s).

Throughout the description and claims the word “comprise” and variations of the word, are not intended to exclude other technical features, additives, components, or steps. Furthermore, the word “comprise” encompasses the case of “consisting of”. Additional objects, advantages and features of the invention will become apparent to those skilled in the art upon examination of the description or may be learned by practice of the invention.

The following examples and drawings are provided by way of illustration, and they are not intended to be limiting of the present invention. Furthermore, the present invention covers all possible combinations of particular and preferred embodiments described herein.

### Examples

### 1. General Considerations

### 1.1. Equipment Specification

### Transmission Electron Microscopy Analysis (TEM)

The experiments were performed at the “Unitat de Microscopia dels Serveis Cientificotècnics de la Universitat Rovira I Virgili” (TEMSCAN) in Tarragona with a JEOL model 1011 electron microscope operating at 100 kV with a resolution of 3 Å. At least 300 Au NPs were manually measured with Image J software. The data were processed with Origin Lab® software fitting a Gaussian function in order to obtain a statistical size distribution and a mean diameter.

### Thermogravimetric Analysis (TGA)

TGA was done using a Mettler-Toledo TGA/SDTA 851e thermobalance (Columbus, OH, USA). All experiments were performed under an inert atmosphere (N₂ at 50 mL/min). Around 10 mg were degraded between 30° C. and 900° C. at a heating rate of 10° C./min.

### Ultraviolet-Visible (UV-Vis)

UV-Vis absorption spectra were recorded of the synthetized materials in standard dispersion between 0.05-3 mg/mL in ultrapure water. Analyses were carried out using quartz cuvette with 1 cm of optical path using a UV-1800 Shimadzu apparatus.

### Optical Microscopy (OM)

Obtained microcapsules were observed by means of Microscope “Axiovert” 40C for transmitted-light brightfield and phase contrast with condenser0.4, inclusive object traverser M, while the micrographs were captured by ZEISS Axiocam 208 digital camera connected to the microscope.

### Field Emission Scanning Electron Microscopy (FESEM)-Energy Dispersive X-Ray Spectroscopy (EDX)

FESEM-EDX were conducted in a Scios 2 Hi Vac de Thermofisher Scientific with EDX detector from Thermofisher.

### Compounding Process

Polymer matrix and natural filler were melt blended using a co-rotating twin screw extruder COPERION ZSK 18MEGAlab with a screw diameter of 18 mm and seven heating zones. Polymer and filler were fed gravimetrically into the feed throat.

### Extruded-Sheet Process

Polymeric sheets were produced by means of a single screw extruder COLLINS TEACH-LINE E 20T with a screw diameter of 20 mm, seven heating zones and sheet die having a nominal width of 80 mm and front opening of 0.2 mm. The extruder is equipped with two drawing units and a hot drawing oven.

### 1.2. Materials

The materials were used without further purification. Hydrogen tetrachloroaurate (III) trihydrate metal precursor and the coupling agent N,N′-Diisopropilcarbodiimide (DIC) were purchased from Alfa Aesar, the stabilizer crystal violet (CV), the linker 3-aminopropiltrietoxisilane (APTES), and the anhydrous solvent methyltetrahydrofuran (Me-THF) from Acros Organics, the supports Titanium (IV) oxide and Zinc oxide (ZnO), the solvent ethylene glycol (EG), the oxidant sodium hydroxide, the stabilizers Trisodium citrate dihydrate, citric acid, and Methylene blue (MB) from Sigma Aldrich. The ethanol solvent came from VWR chemicals. Sodium Alginate (Na-Alginate) was purchased from Roeper in powder form, Vitaflavan was obtained from Purextract and calcium chloride (CaCl₂)) was purchased from Acros Organics. The polymer matrix was polypropylene (PP) injection grade in pellets form, which was obtained from Borealis under the trade mane BF790MO.

### 2. Synthesis of the Materials

### 2.1. Microcapsules 1 (M)

Alginate/Calcium-Vitaflavan microcapsules, containing commercially available product Vitaflavan as biological active compound, were prepared using complex coacervation as disclosed herein below:

Two solutions were prepared:
Solution 1 was prepared by mixing under stirring (350 rpm) in a dark glass vial 298.5 g H₂O(MiliQ), 1.5 g Na-Alginate (0.5 wt % with respect to H₂O) and 15.1 mg Vitaflavan (1 wt % with respect to Na-Alginate)
Solution 2 was prepared by mixing under stirring (350 rpm) 497 g H₂O and 2.5 g CaCl₂)(0.5 wt % with respect to H₂O)

Then, Solution 1 was added to Solution 2 using a nozzle spray system to obtain the microcapsules (I). After the complete addition, the obtained suspension was aged for 24 h at room temperature. Afterwards, the suspension was transferred into a separation funnel and the lower phase containing the Alginate/Calcium-Vitaflavan microcapsules was separated.

Microcapsule morphology was determined by means of Optical Microscopy (OM) and Field Emission Scanning Electron Microscope (FESEM) analysis. The obtained microcapsules (I) were well formed, globular with smooth surface (50 μm).

### 2.2. PP/Na-Alginate Extruded Sheet (PP8)

The extruded sheet was manufactured as follow:

### Step 1: Compounding of PP/Na-Alginate

Before processing, Na-alginate was dried using a convection oven at 80° C. for 8 h. After that, PP/Na-alginate was melt blended in a fixed ratio of 92/8 wt. %, respectively, and defined as PP8 blend using the twin screw extruder machine with a controlled throughput of 7 kg/h. The processing temperature profile in the seven heating zones were set at 160, 160, 180, 180, 180, 180 and 180° C., from the feeding zone to the die, respectively, and the screw speed was fixed at 600 rpm. The extruded compound was water-cooled and pelletized at a constant cutting speed of 1400 rpm.

### Step 2: Sheet-Extrusion of PP8 Compound

Before processing, PP8 material was dried using Piovan hopper-dryer at 80° C. for 5 h.

After that, PP8 extruded sheet was generated by means of single screw equipment. The processing temperature profile in the seven heating zones were set at 160, 160, 180, 180, 180, 180 and 180° C., from the feeding zone to the die, respectively, and the screw speed was fixed at 46 rpm. The extruded sheet was water-cooled before drawing step in the A-B drawing units, in which the drawing speed were set at 3.5 and 3.9 m/s, respectively. The drawing oven temperature was set at 50° C.

Preliminary Characterization: Thermal stability of Na-alginate was analysed by TGA characterization. From the resulting thermogram, it was defined that the maximum loss weight occurred in the temperature range of 180-280° C. Then, the maximal processing temperature of the filler was set at 180° C.

### 2.3. Conjugate APTES-TiO₂@M(2) (Comparative Example)

The preparation process comprises the following steps:

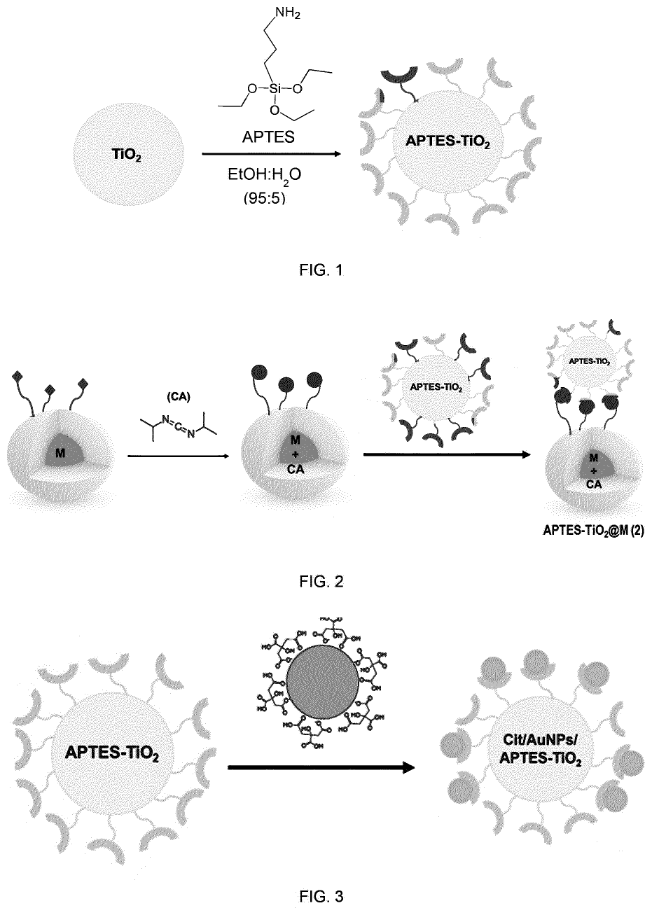

### Step 1: Synthesis of APTES-TiO₂ (See FIG. 1)

A solution of dried TiO₂ NPs (500 mg) commercially available in ethanol: MilliQ H₂O(95:5, 50 mL) was prepared, then APTES (1.5 mL, 6.4 mmol) was added and stirred at room temperature overnight. The mixture was filtered through a Nylon 66 membrane (Filter-Lab, 0.45 μm×47 mm), and washed with ethanol and hexane several times. The final product (474 mg) was dried under vacuum prior to use by Schlenk techniques.

Characterization: A TGA was carried out obtaining a 2% mass loss related to the amino silane wt %, starting the material decomposition at 250° C.

Step 2: Synthesis of APTES-TiO₂@M(2) (See FIG. 2) 5 mL of wet Alginate/Calcium-Vitaflavan microcapsules (prepared as in 2.1) were mixed under stirring at room temperature with 100 mg coupling agent (N,N′-diisopropylcarbodiimide, DIC) for 1 h. Then, 20 mg of APTES-TiO₂ NPs (prepared in step 1) were added, and the suspension was sonicated for 30 min using an ultrasound bath. Finally, the suspension was kept under stirring up to 24 h to ensure the deposition of the APTES-TiO₂ NPs on the surface of the microcapsules. To confirm the microcapsules modification with NPs, samples of the final suspension were collected, washed with MiliQ water, dried for 24 h at room temperature, and analyzed by FESEM and FESEM-EDX.

Characterization: FESEM images of the suspension after 24 h showed that the microcapsule surfaces were well covered with NPs. The images captured with secondary electrons (SE) mode with Everhart-Thornley detector (ETD) detector evidence the presence of NPs with higher molecular weight as white spots which correspond to TiO₂. Moreover, from the micrographs it can be observed that microcapsule surfaces became rugous. The following table shows the elemental composition (atom %) of the analyzed sample in 4 different points (pt1-4).

Atom %

| Sample | C | O | Ti |
|---|---|---|---|
| pt1 | 16.96 | 63.60 | 19.44 |
| pt2 | 17.39 | 61.71 | 20.99 |
| pt3 | 15.93 | 63.34 | 20.73 |
| pt4 | 15.46 | 62.83 | 21.71 |

### 2.4. Conjugate Cit/AuNPs/APTES-TiO₂@M(4) (Comparative Example)

The preparation process comprises the following steps:

### Step 1: Synthesis of Cit/AuNPs

Sodium citrate tribasic dihydrate (5.825 mL, 0.1 M) and citric acid (7 mL, 0.02 M) was mixed with ultrapure H₂O(250 mL) in an Erlenmeyer flask and heated to 100° C. for 15 min. A solution of HAuCl₄·3H₂O(0.42 mL, 0.121 M) was added, and the reaction mixture was maintained at the boiling temperature for further 30 min; after that, it was allowed to cool to RT. Several drops of the resulting dispersion were deposited on a carbon-covered copper grid for transmission electron microscopy analysis (TEM). The grids were dried prior to analysis. Small and spherical nanoparticles with narrow distribution (6.8±1.5 nm) were observed. The nanoparticles suspension was used for the preparation of supported Cit-Au NPS onto APTES-TiO₂ without isolation. The nominal value obtained (20 mg Au) was used to calculate the Au wt % on the next step.

Step 2: Synthesis of Cit/AuNPs/APTES-TiO₂ (See FIG. 3) 180 mg of APTES-TiO₂ (as prepared in step 1 of 2.3) was added to the Cit/AuNPs suspension (20 mg Au) and it was sonicated for 30 min. The solution instantaneously became purple. One drop of the resulting suspension was placed into a Cu grid for TEM analysis. The suspension was filtered using a nylon membrane and washed with water several times to remove excess acid/citrate. The nanoparticles were dried prior to their use for the next step.

TEM analysis showed supported spherical NPs (6.4±1.8 nm).

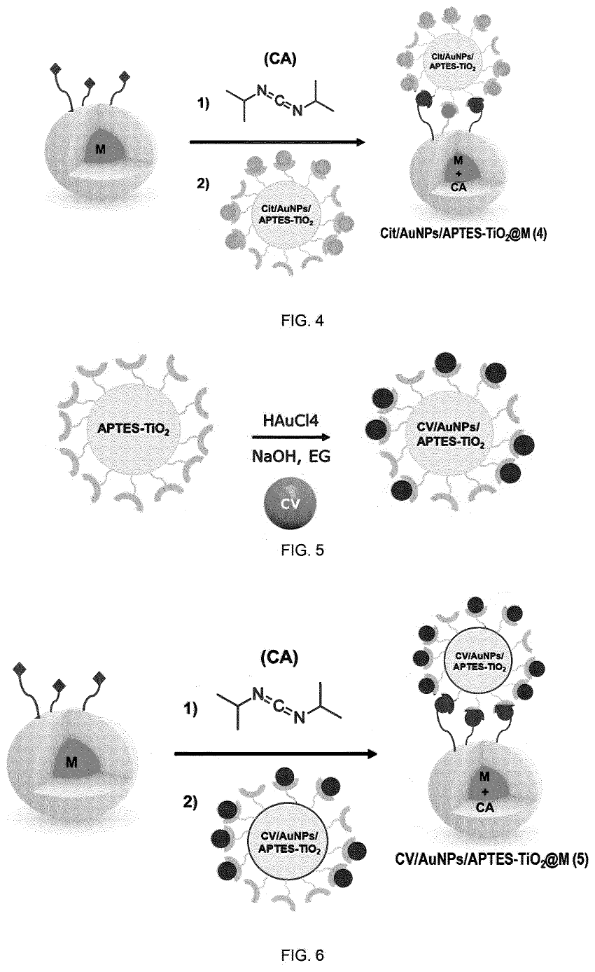

### Step 3: Synthesis of Cit/AuNPs/APTES-TiO₂@M(4) (See FIG. 4)

The Alginate/Calcium-Vitaflavan microcapsules (prepared as in 2.1) were dopped with Cit/AuNPs/APTES-TiO₂ by following the protocol: 5 mL of wet Alginate/Calcium-Vitaflavan microcapsules were mixed under stirring at room temperature with 100 mg coupling agent (N,N′-diisopropylcarbodiimide) for 1 h. Then, 20 mg of Cit/AuNPs/APTES-TiO₂ were added, and the suspension was sonicated for 30 min using an ultrasound bath. Finally, the suspension was kept under stirring up to 24 h to ensure the deposition of the Cit/AuNPs/APTES-TiO₂ on the surface of the microcapsules. To confirm the microcapsules modification with Cit/AuNPs/APTES-TiO₂, samples of the final suspension were collected, washed with MiliQ water, dried for 24 h at room temperature.

### 2.5. Conjugate CV/AuNPs/APTES-TiO₂@M(5) of the Present Invention

The preparation process comprises the following steps:

### Step 1: One Pot Synthesis of CV/AuNPs/APTES-TiO₂ (See FIG. 5)

1.6 mL of a 64.5 mM HAuCl₄ aqueous solution was added into a 0.16 M NaOH, 0.003 M CV solution in ethylene glycol (10 mL) with 180 mg of APTES-TiO₂ NPs (prepared following the process as disclosed above in section 2.3. step 1, nominal metal loading of 10 wt %). Giving 192.1 mg of material with a 95% yield.

TEM results showed that small and spherical Au-NPs with 3.3±0.6 nm diameter were homogeneously distributed on the APTES-TiO₂ support.

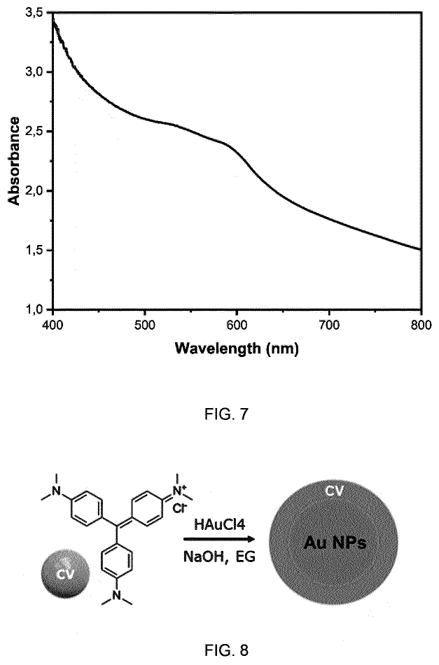

UV-Vis: The UV-vis absorbance spectra of the materials were collected over 400-800 nm wavelengths range in solution (see FIG. 7). The CV/AuNPs/APTES-TiO₂ (5) presents absorbance in this range

Gold recovery tests: Tests for gold recovery were performed allowing recapture of 86 mg Au/g catalyst (8.6 wt % of Au), these results are in agreement with the expected metal loading from the nominal value. A matrix was performed with thiourea (10 g/l) and iron (III) (5 g/l) at pH=1 (adjusted with H₂SO₄ 10N or NaOH 1M, depending on the assay). The total volume used was 2 mL and the solid ratio was 10 mg/mL. For the extraction process, the samples were stirred in a shaker and were maintained at room temperature for 24 h.

At the end of the experiment, all samples were filtered through a compact 0.25 μm filter to remove all possible precipitates formed during the extraction.

### Step 2: Synthesis of CV/AuNPs/APTES-TiO₂@M(5) (See FIG. 6)

The Alginate/Calcium-Vitaflavan microcapsules (prepared as in 2.1) were dopped with CV/AuNPs/APTES-TiO₂ by following the protocol: 5 mL of wet Alginate/Calcium-Vitaflavan microcapsules were mixed under stirring at room temperature with 100 mg coupling agent (N,N′-diisopropylcarbodiimide, DIC) for 1 h. Then, 20 mg of CV/AuNPs/APTES-TiO₂ were added, and the suspension was sonicated for 30 min using an ultrasound bath. Finally, the suspension was kept under stirring up to 24 h to ensure the deposition of the CV/AuNPs/APTES-TiO₂ on the surface of the microcapsules. To confirm the microcapsules modification with CV/AuNPs/APTES-TiO₂, samples of the final suspension were collected, washed with MilliQ water, dried for 24 h at room temperature.

### Characterization

FESEM and FESEM-EDX was carried out to confirm that the NPs are attached to the microcapsule surfaces through crosslinker, and they do not leach during the stirring. At the end, the microcapsules were separated by centrifugation at low speed (2000 rpm, 4 min) to avoid their breakage. It can be observed that CV-AuNPs@TiO₂-APTES NPs have been successfully deposited. To confirm that the white spots visible in the FESEM micrographs are assigned to the NPs, FESEM-EDX was performed. The following table shows the elemental composition (atom %) of the analyzed sample in 4 different points (pt1-4).

Atom %

| Sample | C | O | Ti | Au |
|---|---|---|---|---|
| pt1 | 23.33 | 39.79 | 11.02 | 0.27 |
| pt2 | 23.77 | 34.38 | 9.22 | — |
| pt3 | 22.68 | 44.16 | 10.93 | 0.14 |
| pt4 | 28.51 | 29.33 | 7.02 | 0.12 |

2.6. Gold Nanoparticles Stabilized with Crystal Violet (CV/AuNPs) of the Present Invention

The experimental procedure for the preparation of CV/AuNPs (FIG. 8) consisted in a dropwise addition of a HAuCl₄ aqueous solution (64.5 mM, 0.4 mL) into a 0.16 M NaOH and 0.003 mM CV solution in EG (2.5 mL) (sonication was necessary for the solution preparation) at room temperature and under dark conditions. The mixture was stirred for 120 min (650 rpm). A small amount of the resulting dispersion was sonicated for 1 min and 1 drop was deposited on a carbon-covered copper grid for transmission electron microscopy analysis (TEM). The grids were dried prior to analysis. The rest of the solution was then filtered through a Nylon 66 membrane (Filter-Lab, 0.45 μm×47 mm), and washed with deionized water (DI) several times. The final product (5 mg, 93% yield) was then dried under vacuum to remove the residual solvent.

TEM showed small nanoparticles (4.5±1.0 nm) with narrow distribution and with well-defined spherical shape. TGA was used to determine the presence and amount of CV on the Au NPs surface. The thermogram (A) showed a mass loss of 7%, from 100° C. to 600° C., that correlates with the degradation temperature of the isolated CV. Moreover, can be observed the colour change of the CV-AuNPs from black (B) to gold-coloured (C), characteristic of free Au NPs.

### 2.7. Conjugate CV+Cit/AuNPs/APTES-TiO₂@M(6) (Comparative Example)

The preparation process comprises the following steps:

### Step 1: Synthesis of Cit/AuNPs

The synthesis of Cit/AuNPs was performed following the process as disclosed above in section 2.4. step 1.

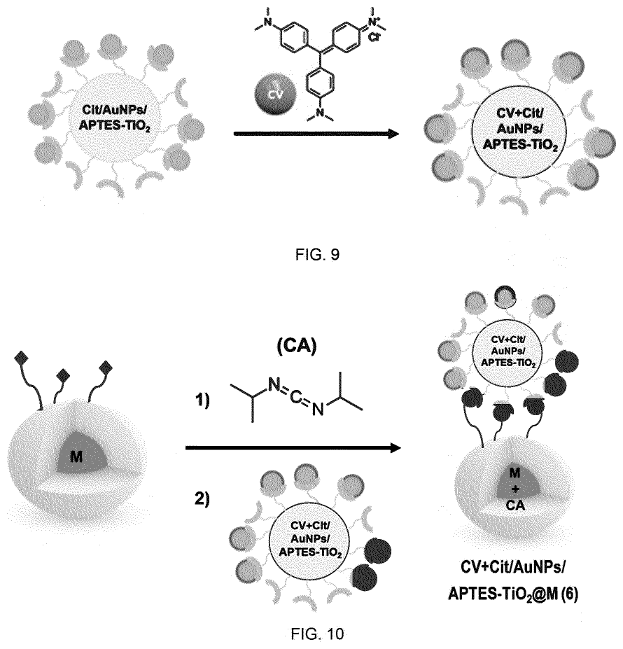

### Step 2: Synthesis of CV+Cit/AuNPs/APTES-TiO₂ (See FIG. 9)

The synthesis of Cit/AuNPs/APTES-TiO₂ was performed following the process as disclosed above in section 2.4. step 2. Then, 3 mM of a solution of crystal violet in deionized water was added, and the suspension was sonicated for 30 min using an ultrasound bath.

### Step 3: Synthesis of CV+Cit/AuNPs/APTES-TiO₂@M(6) (See FIG. 10)

The Alginate/Calcium-Vitaflavan microcapsules were dopped with CV+Cit/AuNPs/APTES-TiO₂ by following the protocol: 5 mL of wet Alginate/Calcium-Vitaflavan microcapsules were mixed under stirring at room temperature with 100 mg coupling agent (N,N′-diisopropylcarbodiimide) for 1 h. Then, 20 mg of CV+Cit/AuNPs/APTES-TiO₂ were added, and the suspension was sonicated for 30 min using an ultrasound bath. Finally, the suspension was kept under stirring up to 24 h to ensure the deposition of the CV+Cit/AuNPs/APTES-TiO₂ on the surface of the microcapsules. To confirm the microcapsules modification with CV+Cit/AuNPs/APTES-TiO₂, samples of the final suspension were collected, washed with MiliQ water, dried for 24 h at room temperature.

### 2.8. Conjugate CV/AuNPs/APTES-TiO₂@PP8 (7) of the Present Invention

The PP/Na-alginate extruded sheet (PP8) (prepared as in 2.2) were dopped with CV/AuNPs/APTES-TiO₂ (prepared as in 2.5 step 1) by following the protocol:

A solution of 1 mL with 5% of coupling agent (N,N′-diisopropylcarbodiimide, DIC) in Me-THF were sprayed over a 3×3 cm surface of PP8 under vacuum conditions. 1 mL of a suspension of CV/AuNPs/APTES-TiO₂ were prepared by sonication using an ultrasound bath for 15 min, and sprayed over the activated-PP8 surface. Then, the samples were dried under ambient conditions overnight and cleaned with ethanol.

Two different materials were prepared containing different loading of the active nanoparticles: (a) CV/AuNPs/APTES-TiO₂@PP8-5.5 mg/cm² (7) and (b) CV/AuNPs/APTES-TiO₂@PP8-0.1 mg/cm² (7′).

FESEM and FESEM-EDX was carried out to confirm that the NPs are attached to the plastic surface through crosslinker. It was observed that CV-AuNPs@TiO₂-APTES NPs have been successfully deposited. To confirm that the white spots visible in the FESEM micrographs are assigned to the NPs, FESEM-EDX was performed. The following table shows the elemental composition (weight %) of the analyzed sample in 3 different points (pt1-2).

wt %

| Sample | |
|---|---|
| 5.5 mg NPs/cm² | 0.1 mg NPs/cm² |

Elements

| | Ti | Au | Ti | Au |
|---|---|---|---|---|
| Pt1 | 13.46 | 2.31 | 0.61 | — |
| Pt2 | 36.56 | 7.19 | 24.08 | 1.52 |
| Pt3 | 38.51 | 7.02 | | |

### 2.9. Conjugate CV/AuNPs/APTES-ZnO of the Present Invention (8)

### Step 1: Synthesis of APTES-ZnO

Example 2.3 Step 1 was repeated using ZnO as semiconductor material. The final product obtained was 490 mg.

### Step 2: Synthesis of CV/AuNPs/APTES-ZnO

Example 2.5. Step 1 was repeated using APTES-ZnO(prepared in Step 1) as support. Giving 181.8 mg of material with a 90% yield.

TEM results showed that small and spherical Au-NPs with 3.0±1.3 nm diameter were homogeneously distributed on the APTES-ZnO support.

The UV—vis absorbance spectrum of the obtained material in solution is shown in FIG. 15.

### 2.10. Conjugate MB/AuNPs/APTES-TiO₂ of the Present Invention (9)

Example 2.5. Step 1 was repeated using Methylene Blue as stabilizer. Giving 185.9 mg of material with a 92% yield.

TEM results showed that small and spherical Au-NPs with 5.5±1.5 nm diameter were homogeneously distributed on the APTES-TiO₂ support.

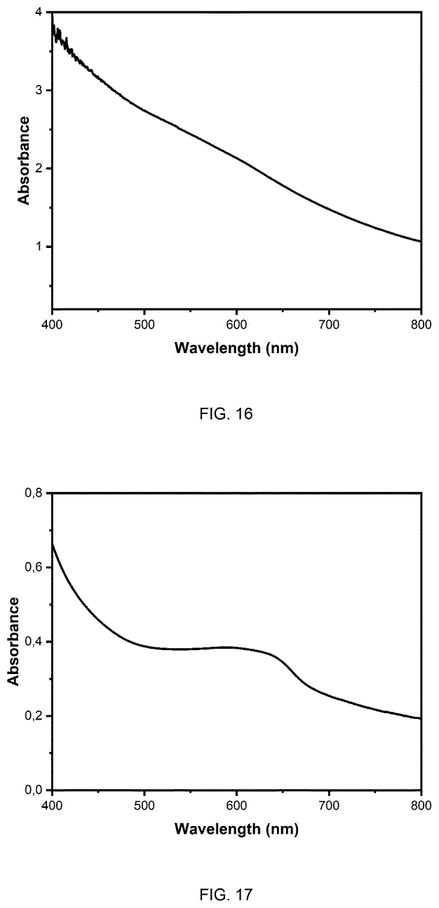

The UV—vis absorbance spectrum of the obtained material in solution is shown in FIG. 16.

### 2.11. Conjugate MB/AuNPs/APTES-ZnO of the Present Invention (10)

Example 2.5. Step 1 was repeated using APTES-ZnO(prepared in 2.9 Step 1) as support and Methylene Blue as stabilizer. Giving 185.8 mg of material with a 92% yield.

TEM results showed that small and spherical Au-NPs with 5.8±2.0 nm diameter were homogeneously distributed on the APTES-ZnO support.

The UV—vis absorbance spectrum of the obtained material in solution is shown in FIG. 17.

### 3. Activity Test

### 3.1. Antiviral Test

### 3.1.1. Cell Culture and Viral Strain

MRC-5 cell line (lung-derived fibroblasts) was used from American Type Culture Collection (ATCC; CCL-171). Cells were maintained at 37° C. and 5% CO₂ in Eagle's Minimal Essential Medium (EMEM) supplemented with 10% fetal bovine serum (FBS) and antibiotics, and were trypsinized every 3-4 days, before reaching 90% confluence. Human coronavirus HuCoV-229E was obtained from ATCC (VR-740) and amplified in MRC-5 cells according to ATTC specifications. MRC-5 cells and HuCoV-229E strain has been used as example being both publicly available from the indicated supplier (ATCC). They have been used for performing the antiviral test of the nanoparticles claimed in the present application. Nevertheless, other publicly available cells or strains equivalent to them can also be used in their place to demonstrate the alleged antiviral effect.

### 3.1.2. Test Product-Virus Contact and Light Exposition

### Test 1: 8W-Power Light Exposure

Sample: Example of the present invention: CV/AuNPs/APTES-TiO₂@M(5)

Method: 0.1 mL of CV/AuNPs/APTES-TiO₂@M(5) was mixed with 0.1 mL of the amplified Human coronavirus HuCoV-229E prepared in previous section with an infectivity titter of 1×10⁶ TCID₅₀/mL in a well of a 48-well plate, per triplicate. Then, the 48-well plate with the viral-sample mix were placed without the lid under two fluorescent 4 W-bulbs, at a distance of 8 cm, at room temperature. Firstly, an experiment in dark conditions (without light exposure) was performed. And, secondly, an experiment with light exposure was performed. In this case, bulbs were turned on for 4 h, and after light exposure, 0.8 mL viral medium (EMEM 2% FBS and Penicillin/Streptomycin) was added to the mix, and serial 10-fold dilutions of each mix were performed in viral medium. As a negative control, in all experiments, a replicate was left untreated (without CV/AuNPs/APTES-TiO₂@M).

Results: The Log₁₀TCID₅₀/reaction was calculated for each tested sample and condition. The Log₁₀TCID₅₀/mL titter was calculated according to the Spearman-Karber formula as disclosed herein below:

$$log ( {TCID}_{50} / mL ) = {x}_{k} + ( \frac{d}{2} ) - d \sum {p}_{i}$$

wherein:
xₖ is the logarithm of the smallest dosage which induced cytopathic effect in all replicates;
d is the logarithm of the dilution factor; and pᵢ is the proportion of positive wells at the dilution i (starting at the highest dilution producing 100% infection).
Values were converted to TCID₅₀/reaction, considering the 0.1 mL inoculum per mix. The detection limit for this assay was 31.62 TCID₅₀/reaction, as calculated by the toxicity produced by the treated material.

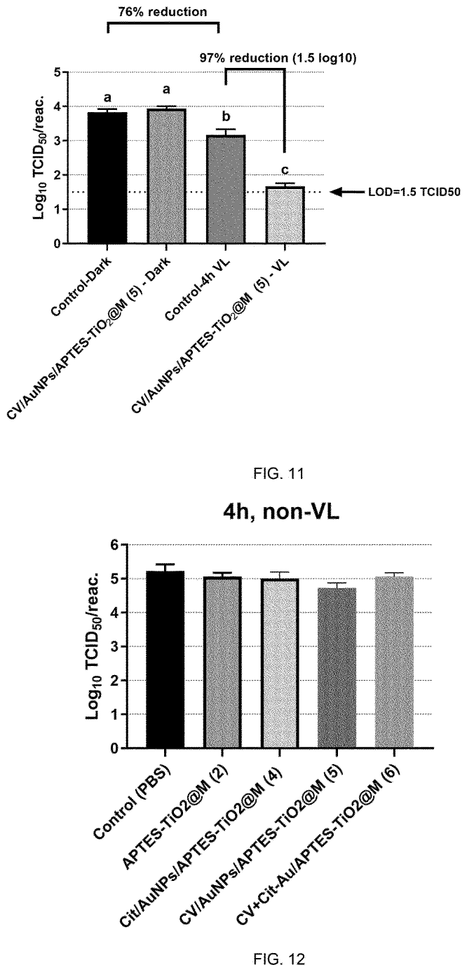

The Log₁₀ TCID₅₀/reaction was calculated for each tested sample and condition and the values obtained are summarized in Table below (see also FIG. 11):

| | Tested conditions | | | |
|---|---|---|---|---|
| | Dark conditions | | Light exposure (4 h) | |
| | | CV/AuNPs/ | | CV/AuNPs/ |
| | Control | APTES-TiO₂@M (5) | Control | APTES-TiO₂@M (5) |
| Log₁₀ TCID₅₀/ | 4.00 | 3.83 | 3.00 | 1.83 |
| reaction | 3.67 | 4.00 | 3.50 | 1.50 |
| | 3.83 | 4.00 | 3.00 | 1.67 |

As it is shown in the obtained results, the exposition of the CV/AuNPs/APTES-TiO₂@M (5) comprising the CV-stabilized AuNPs of the present invention to the virus in dark conditions did not allow reducing the infectivity of the virus. Nevertheless, the exposition of the CV/AuNPs/APTES-TiO₂@M(5) to the virus even at low power light allowed reducing 1.5 logs the infectivity of the virus, which is a reduction of 97% versus control. Therefore, it is demonstrated that the CV-stabilized AuNPs of the present invention are effective against virus infection, particularly for reducing the infectivity of the virus, and that the mechanism for microorganism deactivation is photocatalytic.

### Test 2: 18W-Power Light Exposure

### Samples:

Example of the present invention: CV/AuNPs/APTES-TiO₂@M(5)
Comparative Examples: negative Control (PSB), APTES-TiO₂@M(2), Cit/Au/APTES-TiO₂@M(4), CV+Cit/Au/APTES-TiO₂@M(6)

Method: 0.1 mL of each tested sample was mixed with 0.1 mL of the amplified Human coronavirus HuCoV-229E prepared in previous section with an infectivity titter of 7.5×10⁶ TCID₅₀/mL in a well of a 48-well plate, per triplicate. Then, the 48-well plate with the viral-sample mix were placed without the lid under two fluorescent 9 W-bulbs (MZT80960; MiaLuz), at a distance of 8 cm, at room temperature. Firstly, an experiment in dark conditions (without light exposure) was performed. And, secondly, an experiment with light exposure was performed. In this case, bulbs were turned on for 240 min, and after 15 min, 30 min, 60 min, and 240 min of light exposure, 0.8 mL viral medium (EMEM 2% FBS and Penicillin/Streptomycin) was added to the mix, and serial 10-fold dilutions of each mix were performed in viral medium. As a negative control, in all experiments, a replicate was left untreated (without CV/AuNPs/APTES-TiO₂@M).

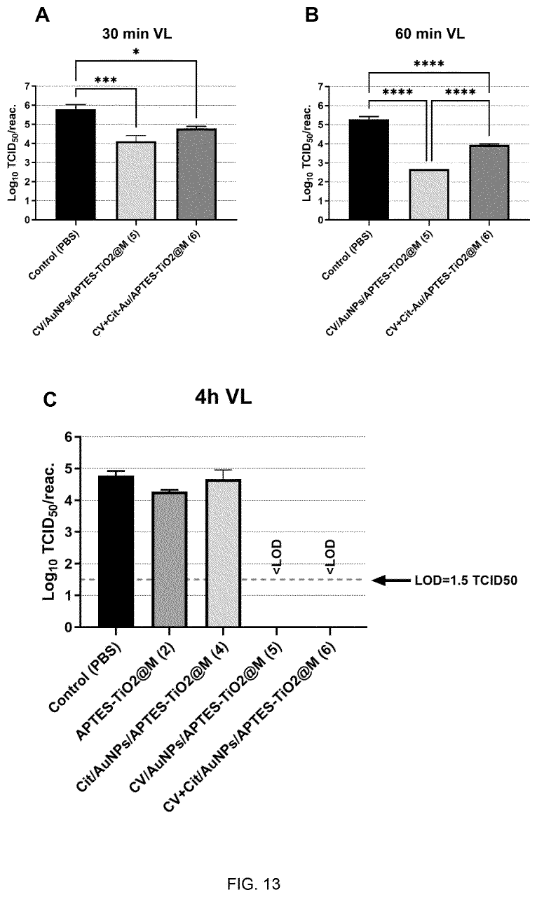

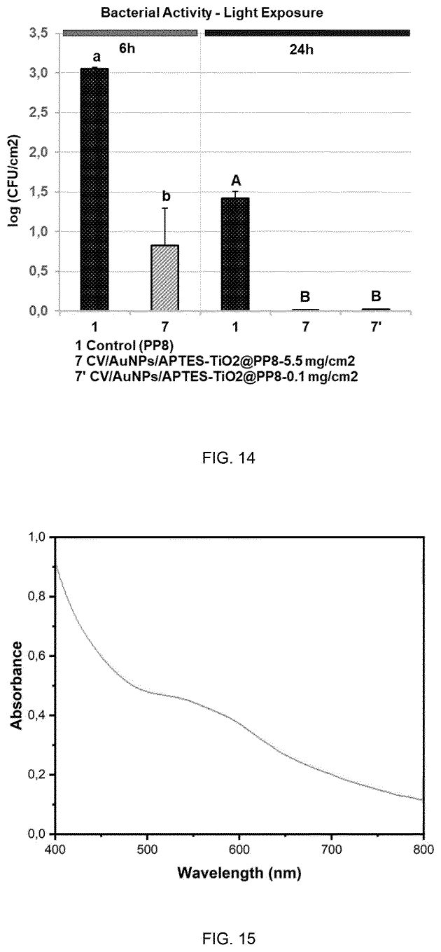

Results: The Log₁₀TCID₅₀/reaction values obtained for dark experiments and light exposure experiments (at 30, 60 and 240 min) are shown in FIG. 12 and FIG. 13, respectively.

As can be seen in FIG. 11 the exposition of all tested samples including the CV/AuNPs/APTES-TiO₂@M(5) comprising the CV-stabilized AuNPs of the present invention to the virus in dark conditions did not allow reducing the infectivity of the virus.

By contrast, the exposition of the CV/AuNPs/APTES-TiO₂@M(5) to the virus under light conditions showed efficacy in reducing the infectivity of the virus from 30 min (FIG. 13A) and 60 min (FIG. 13B), achieving its highest efficacy at about 4 h (FIG. 13C). It is remarkable that at 30 min the reduction of the virus infectivity was higher not only with respect to the control but also with respect to the comparative conjugates in particular CV+Cit/AuNPs/APTES-TiO₂@M(6), which means that the conjugates of the invention are capable of increasing the resistance of virus infection by human cells at an earlier stage (30 min).

### 3.2. Antibacterial Activity

### 3.2.1. Bacterial Strain

Staphylococcus aureus was used in this assay. The strain was purchased from American Type Culture Collection (ATCC, N° 6538). Two days before the test, bacteria were transferred from frozen stock cultures onto a TSA plates and then incubated at 37±1° C. for 20±4 hours (stock 1). One day before the test, bacteria from stock 1 were transferred to other TSA plates, incubated at 37±1° C. for 20±4 hours and then, some of the bacteria from these pre-incubated plates, were suspended into nutrient broth.

The number of bacteria in the initial suspension was 3×10⁶ CFU/mL. This suspension was used as inoculum for the test of the surfaces. However, other equivalent strains can also be used in addition to demonstrate the antibacterial activity.

### 3.2.2. Product-Bacteria Contact and Light Exposition Test

### Test 1: 18W Light Exposure

Method: Each surface (Control (PP8), CV/AuNPs/APTES-TiO₂@PP8-5.5 mg/cm² (7), CV/AuNPs/APTES-TiO₂@PP8-0.1 mg/cm² (7′)), 20×20 mm, in triplicate, was placed into a well of a 6-well plate. Then, 0.2 mL of the test inoculum prepared in the previous section was added on each surface and these were covered with a film (16×16 mm), ensuring that the inoculum spread towards the edges and remained in intimate contact with the test surface. Subsequently, the 6-well plate was placed, without the lid, under two fluorescent 9 W-bulbs (MZT80960; MiaLuz), at a distance of 8 cm, at 25±1° C. for 6 h and 24 h. After incubation, 10 mL of neutraliser was added to each well containing the samples to facilitate the recovery of any surviving bacteria. Then, 100 μL of the neutralising solution obtained from each of the analyzed samples was inoculated to obtain the bacterial concentration (CFU/mL) using TSA plate count. After inoculation, the Petri dishes were incubated at 35±1° C. for 22±2 h. Finally, the CFUs on the plates were counted and recorded.

Results: The microbiological effects obtained are based on the difference between the populations present in the untreated (control) and treated material and this is used to describe the impact of the treatment on the population. The bacterial growth values obtained after antibacterial activity assays are shown in the following table (see also FIG. 15). The results are expressed as base-10 logarithm (Log₁₀) of the means of the population values obtained from each untreated (control) and treated surface (CFU/cm² (film area)) and they are tested for statistical significance (p<0.05) using one-way ANOVA (Tukey post hoc)

| | | Mean ± SEM |
|---|---|---|
| | Surfaces | (log CFU/cm²) |
| 6 h | Control (PP8) | 3.05 ± 0.02 |
| | CV/AuNPs/APTES-TiO₂@PP8-5.5 mg/cm² (7) | 0.83 ± 0.47 |
| 24 h | Control (PP8) | 1.42 ± 0.08 |
| | CV/AuNPs/APTES-TiO₂@PP8-5.5 mg/cm² (7) | 0.02 ± 0.00 |
| | CV/AuNPs/APTES-TiO₂@PP8-0.1 mg/cm² (7′) | 0.02 ± 0.00 |

As can be seen, light exposure of the CV/AuNPs/APTES-TiO₂@PP8-5.5 mg/cm² (7) surface showed a significant decrease in bacterial activity after 6 h of exposure compared to the control surface. Moreover, as observed, light exposure of both treated surfaces (CV/AuNPs/APTES-TiO₂@PP8-5.5 mg/cm² (7) and CV/AuNPs/APTES-TiO₂@PP8-0.1 mg/cm² (7′)) at 24 h also showed a significant decrease in bacterial activity compared to their control. Therefore, it has been demonstrated that these surfaces are efficient, reducing bacterial activity by around 99% after 6 h of light exposure and maintaining this decrease until 24 h of exposure. Additionally, it is confirmed that the decrease in the active NPs (CV/AuNPs/APTES-TiO₂) concentration onto the macroscopic support (PP8) does not affect the decrease in bacterial activity, which remains around 99% at 24 h of exposure.

### CITATION LIST

Maslov et al: “Theoretical and experimental studies aimed at the development of vortex—assisted supramolecular solvent microextraction far determination of nickel in plant samples by FAAS”, Microchemical Journal 2020, vol. 159, pp 1-7
US858030982
US2009317436
Wybieralska et al: “Removal of organic dyes from aqueous solutions with surfactant—modified magnetic nanoparticles”, Polish Journal of Chemical Technology 2014, vol. 16, no. 2, pages 27-30
Bakshi et al: “Dependence of Crystal Growth of Gold Nanoparticles on the Capping Behavior of Surfactant at Ambient Conditions”, Crystal Growth & Design 2008, vol. 8, no. 5, pages 1713-1719
Tawfik et al: “Photodynamic antibacterial enhanced effect of methylene blue-gold nanoparticles conjugate on Staphylococcal aureus isolated from impetigo lesions in vitro study”, Photodiagnosis and Photodynamic Therapy 2015, vol. 12, no. 2, pages 215-220

What is claimed is:

1. A metal nanoparticle which comprises a metal and a capping agent coordinated to the metal, wherein the capping agent is a salt of a cationic compound capable of absorbing visible light.

2. The metal nanoparticle according to claim 1, wherein the salt of the cationic compound is capable of absorbing visible light from 400 to 800 nm.

3. The metal nanoparticle according to claim 1, wherein the salt of the cationic compound capable of absorbing visible light is selected from the group consisting of an ammonium salt, a sulfonium salt, a phosphonium salt, and a mixture thereof.

4. The metal nanoparticle according to claim 3, wherein the salt of the cationic compound capable of absorbing visible light is selected from the group consisting of crystal violet, toluidine blue, methylene blue, malachite green and mixtures thereof.

5. The metal nanoparticle according to claim 1, wherein the metal is selected from the group consisting of gold, platinum, silver, palladium, osmium, ruthenium, rhodium, rhenium, molybdenum, copper, iron, nickel, tin, beryllium, cobalt, antimony, chromium, manganese, zirconium, tin, zinc, tungsten, titanium, vanadium, lanthanum, cerium, an alloy thereof, an oxide thereof, and a mixture thereof.

6. A semiconductor metal oxide nanoparticle comprising a semiconductor metal oxide core which is covalently attached to a plurality of linkers, wherein one or more of the said linkers are coordinated to one or more of the metal nanoparticles as defined in claim 1.

7. The semiconductor metal oxide nanoparticle according to claim 6, wherein the semiconductor metal oxide is titanium oxide or zinc oxide.

8. The semiconductor metal oxide nanoparticle according to claim 6, wherein the linkers have the formula (I): 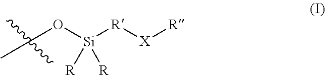
wherein:
each R independently is —(C₁-C₆)alkyl or —O(C₁-C₆)alkyl,
R′ is selected from the group consisting of —(CH₂)ₙ—, —CH(YH)—(CH₂)ₙ—, —(CH₂)ₙ—Y—(CH₂)ₘ—, and —(CH₂)ₙ—Y—(CH₂)ₘ—Y′—(CH₂)ₚ—,
n, m and p are integers from 1 to 6,
X, Y, and Y′ are selected from the group consisting of —O—, —S— and —NH—,
R″ is —H or —(C₁-C₃)alkyl, and
the wavy line represents the attachment point to the semiconductor metal oxide nanoparticle core.

9. The semiconductor metal oxide nanoparticle according to claim 8, wherein in the linkers of formula (I), each R is ethoxy, R′ is —(CH₂)₃—, X is —NH—, and R″ is —H.

10. A functionalised material which comprises a plurality of semiconductor metal oxide nanoparticles, wherein the semiconductor metal oxide nanoparticles comprise a semiconductor metal oxide core which is covalently attached to a plurality of linkers, wherein one or more of the said linkers are further coordinated to one or more of the metal nanoparticles as defined in claim 1, and one or more of the said linkers different from the linkers coordinated to the metal nanoparticles are further covalently attached to the surface of the material.

11. The functionalised material according to claim 10, which is a mineral or a glass material in the form of a sheet, a polymeric material in the form of a film, or a polymeric material in the form of beads of micrometric size.

12. A photocatalytic paint which comprises the semiconductor metal oxide nanoparticles as defined in claim 6.

13. A method for the treatment or prevention of a viral disease or a bacterial infection, which comprises administering to a subject in need thereof, including a human, the semiconductor metal oxide nanoparticles as defined in claim 6.

14. A method for disinfecting a solid surface comprising applying the semiconductor metal oxide nanoparticles as defined in claim 6.

15. A method for removing Volatile Organic Compounds (VOCs) from an air or a water supply, comprising contacting the semiconductor metal oxide nanoparticles as defined in claim 6 with the air or water supply.

16. A method for producing hydrogen by water splitting Volatile Organic Compounds (VOCs) from of an air or water supply comprising contacting the semiconductor metal oxide nanoparticles as defined in claim 6 with water.

17. A metal nanoparticle which comprises a metal and a capping agent coordinated to the metal, wherein the capping agent is a salt of a cationic compound capable of absorbing visible light; wherein the salt of the cationic compound capable of absorbing visible light is selected from the group consisting of an ammonium salt, a sulfonium salt, a phosphonium salt, and a mixture thereof, and wherein the metal is selected from the group consisting of gold, platinum, silver, palladium, osmium, ruthenium, rhodium, rhenium, molybdenum, copper, iron, nickel, tin, beryllium, cobalt, antimony, chromium, manganese, zirconium, tin, zinc, tungsten, titanium, vanadium, lanthanum, cerium, an alloy thereof, an oxide thereof, and a mixture thereof.

18. A semiconductor metal oxide nanoparticle comprising a semiconductor metal oxide core which is covalently attached to a plurality of linkers, wherein one or more of the said linkers are coordinated to one or more of the metal nanoparticles as defined in claim 1, wherein the semiconductor metal oxide is titanium oxide or zinc oxide, and wherein the linkers have the formula (I): 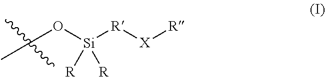
wherein:
each R independently is —(C₁-C₆)alkyl or —O(C₁-C₆)alkyl,
R′ is selected from the group consisting of —(CH₂)ₙ—, —CH(YH)—(CH₂)ₙ—, —(CH₂)ₙ—Y—(CH₂)ₘ—, and —(CH₂)ₙ—Y—(CH₂)ₘ—Y′—(CH₂)ₚ—,
n, m and p are integers from 1 to 6,
X, Y, and Y′ are selected from the group consisting of —O—, —S— and —NH—,
R″ is —H or —(C₁-C₃)alkyl, and
the wavy line represents the attachment point to the semiconductor metal oxide nanoparticle core.

19. A semiconductor metal oxide nanoparticle comprising a semiconductor metal oxide core which is covalently attached to a plurality of linkers, wherein one or more of the said linkers are coordinated to one or more of the metal nanoparticles as defined in claim 3, wherein the semiconductor metal oxide is titanium oxide or zinc oxide, and wherein the linkers have the formula (I): 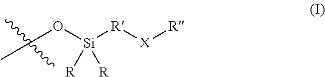
wherein:
each R independently is —(C₁-C₆)alkyl or —O(C₁-C₆)alkyl,
R′ is selected from the group consisting of —(CH₂)ₙ—, —CH(YH)—(CH₂)ₙ—, —(CH₂)ₙ—Y—(CH₂)ₘ—, and —(CH₂)ₙ—Y—(CH₂)ₘ—Y′—(CH₂)ₚ—,
n, m and p are integers from 1 to 6,
X, Y, and Y′ are selected from the group consisting of —O—, —S— and —NH—,
R″ is —H or —(C₁-C₃)alkyl, and
the wavy line represents the attachment point to the semiconductor metal oxide nanoparticle core.

20. A semiconductor metal oxide nanoparticle comprising a semiconductor metal oxide core which is covalently attached to a plurality of linkers, wherein one or more of the said linkers are coordinated to one or more of the metal nanoparticles as defined in claim 17, wherein the semiconductor metal oxide is titanium oxide or zinc oxide, and wherein the linkers have the formula (I): 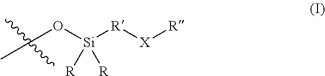
wherein:
each R independently is —(C₁-C₆)alkyl or —O(C₁-C₆)alkyl,
R′ is selected from the group consisting of —(CH₂)ₙ—, —CH(YH)—(CH₂)ₙ—, —(CH₂)ₙ—Y—(CH₂)ₘ—, and —(CH₂)ₙ—Y—(CH₂)ₘ—Y′—(CH₂)ₚ—,
n, m and p are integers from 1 to 6,
X, Y, and Y′ are selected from the group consisting of —O—, —S— and —NH—,
R″ is —H or —(C₁-C₃)alkyl, and
the wavy line represents the attachment point to the semiconductor metal oxide nanoparticle core.
